(19) United States
(12) Patent Application Publication
(10) Pub. No.: US 2024/0284448 A1
(43) Pub. Date: Aug. 22, 2024

(54) METHOD, APPARATUS, AND COMPUTER PROGRAM PRODUCT FOR REPORTING OF USER EQUIPMENT TIME-FREQUENCY COMPENSATION TIMING

(71) Applicant: Nokia Technologies Oy, Espoo (FI)

(72) Inventors: Arman AHMADZADEH, Munich (DE); Alessio MARCONE, Munich (DE); Frank FREDERIKSEN, Aalborg (DK)

(21) Appl. No.: 18/443,240

(22) Filed: Feb. 15, 2024

Related U.S. Application Data
(60) Provisional application No. 63/485,870, filed on Feb. 17, 2023.

(51) Int. Cl. H04W 72/1268; H04L 5/00; H04W 72/0446; H04W 72/0453

(52) U.S. Cl. CPC H04W 72/1268; H04L 5/0051; H04W 72/0446; H04W 72/0453

(57) ABSTRACT

A method, apparatus, and computer program product are disclosed for reporting time and frequency compensation updates to a base station in a 5G network. In this regard, an example method is configured to determine an actual time domain window based at least in part on a time domain window received at the user equipment from a base station, and on at least one adjustment to at least one of time or frequency of a reference signal due to a physical characteristic of a transmission environment. The example method may further cause a compensation report to be transmitted to the base station in a control channel message within the uplink communication stream. The compensation report includes an indication of the at least one adjustment. The method further causes the reference signal to be transmitted in the actual time domain window to the base station.

### TECHNOLOGICAL FIELD

An example embodiment relates generally to providing a compensation report to a base station, and, more particularly, notifying a base station of timing and frequency adjustments to a reference signal in an uplink communication stream.

### BACKGROUND

In fifth generation (5G) networks, a demodulation reference signal (DMRS) is utilized to enable reliable and efficient communication between a base station and user equipment (UE) on a physical channel. The DMRS is often transmitted along with transmitted data to provide a reference signal, facilitating more accurate demodulation of the transmitted data. One way in which a transmitted DMRS enables a receiver to more accurately demodulate the transmitted data is by performing channel estimation. Channel estimation involves estimating the characteristics of the communication channel between the transmitter and receiver, such that the transmitted data may be decoded more accurately. The receiver uses the reference signal (e.g., DMRS) to estimate channel characteristics such as signal delay, amplitude shifting, phase shifts, speed/distance of the transmitter and receiver, and other anomalies. Enabling channel estimation using the DMRS is essential to enabling advanced 5G features such as beamforming, spatial multiplexing, multiple input multiple output (MIMO) communication, and communication on non-terrestrial networks (NTN).

A DMRS bundling framework has further been introduced to improve the performance of channel estimation and provide performance gain in 5G communication. The legacy DMRS framework transmitted one or more time domain symbols across multiple resource blocks in the frequency domain. However, the legacy DMRS framework only transmitted these symbols in one slot. As such, the base station could perform channel estimation using the legacy DMRS framework, but only for the particular slot. DMRS bundling expands upon the legacy DMRS framework to allow the DMRS to be transmitted across multiple slots. With the transmission of DMRS across multiple slots, joint channel estimation can be performed at the base station side, which can improve the performance of channel estimation and coverage. As described, DMRS bundling involves transmitting DMRS symbols within multiple slots such that joint channel estimation may be performed across the transmitted slots. To realize the performance gain of DMRS bundling, several conditions must first be met. For example, the communication channel/channels must be relatively static, meaning the time variation between the channels is under a particular threshold. In addition, the UE is required to maintain power consistency and phase continuity across the transmitted DMRS symbols in consecutive slots within a configured time domain window (TDW). Receiving multiple coherent (meeting the phase and power continuity requirement) DMRS symbols enables the components of the 5G network to more accurately estimate the characteristics of the physical channel and improve coverage.

In some applications, standards establish a maximum allowable phase difference across DMRS symbols in a DMRS bundle. To ensure that the base station and UE coordinate on the number of slots wherein DMRS bundling has occurred, the concept of time domain window, wherein power consistency and phase continuity is kept, was introduced within a DMRS bundling framework. Coordination between the base station and UE is generally achieved by allowing the base station to configure a nominal time domain window, within which multiple actual TDWs may be created. A nominal TDW defines the time interval in which the DMRS symbols may be transmitted coherently, such that there is an underlying assumption of continuous operation where consistency between slots may be assumed. A nominal TDW is a wider time domain window than the DMRS bundling framework generally applies. As such, the nominal TDW may consist of multiple actual TDWs. An actual TDW is a time domain window through with the UE transmits multiple physical uplink shared channel (PUSCH) messages, including associated DMRS symbols. Coherent transmission of the PUSCH messages and associated DMRS symbols within the actual TDW requires phase continuity and power consistency. An actual TDW may be comprised in one nominal TDW and may be generated autonomously at the UE based on certain standardized conditions and events. Some of these events may disrupt the continuous operation and thereby create an actual TDW differing from the nominal TDW. Events disrupting the continuous operation may lead to a scenario in which the UE cannot maintain phase continuity. Such events may require the UE to compensate transmissions in order to maintain coherency. The update of the timing advance (TA) of its uplink transmissions by a UE may be regarded as an event breaking the phase and power consistency.

### BRIEF SUMMARY

A method, apparatus, and computer program product are disclosed for reporting time and frequency compensation updates to a base station in a 5G network. In one embodiment, a method is provided. The method may comprise receiving, at a user equipment, information defining a time domain window from a base station, wherein the time domain window indicates a time window in an uplink communication stream in which at least a reference signal is to be transmitted. The method may further comprise determining an actual time domain window, wherein the actual time domain window is based at least in part on the information defining the time domain window in the uplink communication stream and on at least one adjustment to at least one of time or frequency of a reference signal due to a physical characteristic of a transmission environment. Additionally, the method may comprise causing a compensation report to be transmitted to the base station in a control channel message within the uplink communication stream, wherein the compensation report comprises an indication of the at least one adjustment. The method may further comprise causing the reference signal to be transmitted in the actual time domain window to the base station.

In some embodiments, the method may further comprise generating the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the method may further comprise causing the control channel message to be transmitted in accordance with a physical uplink control channel (PUCCH).

In some embodiments, the method may further comprise causing the compensation report to be transmitted in a dedicated data field of the control channel message.

In some embodiments, the method may further comprise causing the compensation report to be transmitted in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the method may further comprise assigning a subset of control channel resources to a compensation resource set group, and in an instance in which the compensation report is updated, causing the compensation report to be transmitted on an available compensation resource set in a control channel message.

In some embodiments, the uplink communication stream may comprise one or more shared channel repetitions and the method further comprises causing the compensation report to be transmitted in coordination with the shared channel repetitions.

In some embodiments, the method may further comprise causing the compensation report to be transmitted after the shared channel repetitions, wherein the compensation report indicates the at least one adjustment for a previously transmitted reference signal.

In some embodiments, the shared channel repetitions may include at least a first shared channel repetition and a second shared channel repetition, wherein in an instance in which the first shared channel repetition does not fill an allotted time slot for shared channel repetitions, the method may further comprise causing the compensation report indicating the at least one adjustment of the reference signal to be transmitted in the control channel message after the first shared channel repetition and before the second shared channel repetition.

In some embodiments, the compensation report may acknowledge transmission of the reference signal wherein the at least one adjustment has been or will be applied.

In some embodiments, the method may further comprise causing the compensation report to be transmitted before the shared channel repetitions, wherein the compensation report indicates the at least one adjustment for a future reference signal.

In another embodiment, an apparatus is provided. The apparatus may include at least one processor and at least one memory including computer program code, the at least one memory and the computer program code configured to, with the at least one processor, cause the apparatus to receive information defining a time domain window from a base station, wherein the time domain window indicates a time window in an uplink communication stream in which a reference signal is to be transmitted; determine an actual time domain window, wherein the actual time domain window is based at least in part on the information defining the time domain window in the uplink communication stream and on at least one adjustment to at least one of time or frequency of a reference signal due to a physical characteristic of a transmission environment; cause a compensation report to be transmitted to the base station in a control channel message within the uplink communication stream, wherein the compensation report comprises an indication of the at least one adjustment; and cause the reference signal to be transmitted in the actual time domain window to the base station.

In some embodiments, the at least one memory and the computer program code may be configured to with the at least one processor, cause the apparatus to generate the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the at least one memory and the computer program code may be configured to with the at least one processor, cause the apparatus to cause the control channel message to be transmitted in accordance with a physical uplink control channel (PUCCH).

In some embodiments, the at least one memory and the computer program code may be configured to with the at least one processor, cause the apparatus to cause the compensation report to be transmitted in a dedicated data field of the control channel message.

In some embodiments, the at least one memory and the computer program code may be configured to with the at least one processor, cause the apparatus to cause the compensation report to be transmitted in a shared data field of the control channel message.

In some embodiments, the shared data field may comprise a base sequence, wherein the compensation report is encoded by applying a cyclic shift to the base sequence.

In some embodiments, the shared data field may be at least one of a modulation symbol data field or a resource selection data field.

In some embodiments, the at least one memory and the computer program code may be configured to with the at least one processor, cause the apparatus to assign a subset of control channel resource to a compensation resource set group, and in an instance in which the compensation report is updated, cause the compensation report to be transmitted on an available compensation resource set in a control channel message.

In some embodiments, the uplink communication stream may comprise one or more shared channel repetitions and wherein the at least one memory and the computer program code are configured to with the at least one processor, cause the apparatus to cause the compensation report to be transmitted in coordination with the shared channel repetitions.

In some embodiments, the at least one memory and the computer program code may be configured to with the at least one processor, cause the apparatus to cause the compensation report to be transmitted after the shared channel repetitions, wherein the compensation report indicates the at least one adjustment for a previously transmitted reference signal.

In some embodiments, in an instance in which the one or more shared channel repetitions do not fill an allotted time slot for shared channel repetitions, the at least one memory and the computer program code may be configured to with the at least one processor, cause the apparatus to cause an acknowledge control channel message indicating the at least one adjustment of the reference signal to be transmitted.

In some embodiments, the compensation report may acknowledge transmission of the reference signal wherein the at least one adjustment has been or will be applied.

In some embodiments, the at least one memory and the computer program code may be configured to with the at least one processor, cause the apparatus to cause the compensation report to be transmitted before the shared channel repetitions, wherein the compensation report indicates the at least one adjustment for a future reference signal.

In another embodiment, a computer program product comprising at least one non-transitory computer-readable storage medium having computer-readable program code portions stored therein, the computer-readable program code portions comprising an executable portion configured to receive, at a user equipment, information defining a time domain window from a base station, wherein the time domain window indicates a time window in an uplink communication stream in which at least a reference signal is to be transmitted. The computer program product may be further configured to determine an actual time domain window, wherein the actual time domain window is based at least in part on the information defining the time domain window in the uplink communication stream and on at least one adjustment to at least one of time or frequency of a reference signal due to a physical characteristic of a transmission environment. The computer program product may be further configured to cause a compensation report to be transmitted to the base station in a control channel message within the uplink communication stream, wherein the compensation report comprises an indication of the at least one adjustment. The computer program product may be further configured to cause the reference signal to be transmitted in the actual time domain window to the base station.

In some embodiments, the computer program product may be further configured to generate the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the computer program product may be further configured to cause the control channel message to be transmitted in accordance with a physical uplink control channel (PUCCH).

In some embodiments, the computer program product may be further configured to cause the compensation report to be transmitted in a dedicated data field of the control channel message.

In some embodiments, the computer program product may be further configured to cause the compensation report to be transmitted in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the computer program product may be further configured to assign a subset of control channel resources to a compensation resource set group, and in an instance in which the compensation report is updated, causing the compensation report to be transmitted on an available compensation resource set in a control channel message.

In some embodiments, the uplink communication stream may comprise one or more shared channel repetitions and the method further comprises causing the compensation report to be transmitted in coordination with the shared channel repetitions.

In some embodiments, the computer program product may be further configured to cause the compensation report to be transmitted after the shared channel repetitions, wherein the compensation report indicates the at least one adjustment for a previously transmitted reference signal.

In some embodiments, the shared channel repetitions may include at least a first shared channel repetition and a second shared channel repetition, wherein in an instance in which the first shared channel repetition does not fill an allotted time slot for shared channel repetitions, the method may further comprise causing the compensation report indicating the at least one adjustment of the reference signal to be transmitted in the control channel message after the first shared channel repetition and before the second shared channel repetition.

In some embodiments, the compensation report may acknowledge transmission of the reference signal wherein the at least one adjustment has been or will be applied.

In some embodiments, the computer program product may be further configured to cause the compensation report to be transmitted before the shared channel repetitions, wherein the compensation report indicates the at least one adjustment for a future reference signal.

In another embodiment, an apparatus is provided. The apparatus may comprise means for receiving, at a user equipment, information defining a time domain window from a base station, wherein the time domain window indicates a time window in an uplink communication stream in which a reference signal is to be transmitted; means for determining an actual time domain window, wherein the actual time domain window is based at least in part on the information defining the time domain window in the uplink communication stream and on at least one adjustment to at least one of time or frequency of a reference signal due to a physical characteristic of a transmission environment; means for causing a compensation report to be transmitted to the base station in a control channel message within the uplink communication stream, wherein the compensation report comprises an indication of the at least one adjustment; and means for causing the reference signal to be transmitted in the actual time domain window to the base station.

In some embodiments, the apparatus may further comprise means for generating the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the apparatus may further comprise means for causing the control channel message to be transmitted in accordance with a physical uplink control channel (PUCCH).

In some embodiments, the apparatus may further comprise means for causing the compensation report to be transmitted in a dedicated data field of the control channel message.

In some embodiments, the apparatus may further comprise means for causing the compensation report to be transmitted in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the apparatus may further comprise means for assigning a subset of control channel resources to a compensation resource set group, and in an instance in which the compensation report is updated, causing the compensation report to be transmitted on an available compensation resource set in a control channel message.

In some embodiments, the uplink communication stream may comprise one or more shared channel repetitions and the apparatus further comprises means for causing the compensation report to be transmitted in coordination with the shared channel repetitions.

In some embodiments, the apparatus may further comprise means for causing the compensation report to be transmitted after the shared channel repetitions, wherein the compensation report indicates the at least one adjustment for a previously transmitted reference signal.

In some embodiments, wherein in an instance in which the one or more shared channel repetitions do not fill an allotted time slot for shared channel repetitions, the apparatus may further comprise means for causing an acknowledge control channel message indicating the at least one adjustment of the reference signal to be transmitted.

In some embodiments, the compensation report may acknowledge transmission of the reference signal wherein the at least one adjustment has been or will be applied.

In some embodiments, the apparatus may further comprise means for causing the compensation report to be transmitted before the shared channel repetitions, wherein the compensation report indicates the at least one adjustment for a future reference signal.

In another embodiment, a method is provided. In some embodiments, the method may comprise causing information defining a time domain window to be transmitted toward a user equipment, wherein the time domain window indicates a time window in an uplink communication stream in which a reference signal is to be transmitted; receiving a compensation report from the user equipment in a control channel message within the uplink communication stream, wherein the compensation report comprises an indication of at least one adjustment to at least one of time or frequency of the reference signal due to a physical characteristic of a transmission environment; and receiving the reference signal in an actual time domain window from the user equipment, wherein the actual time domain window is based at least in part on the at least one adjustment.

In some embodiments, the method may further comprise, receiving the compensation report comprising compensation information related to at least one of a frequency adjustment and a timing adjustment.

In some embodiments, the physical characteristic of the transmission environment comprises at least one of a transmission medium physical characteristic, a base station physical location, or a user equipment physical location.

In some embodiments, the method may further comprise receiving the control channel message in accordance with a physical uplink control channel (PUCCH).

In some embodiments, the method may further comprise receiving the compensation report in a dedicated data field of the control channel message.

In some embodiments, the method may further comprise receiving the compensation report in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the method may further comprise receiving the compensation report on a compensation resource set in a control channel message.

In some embodiments, the uplink communication stream may comprise one or more shared channel repetitions and the method further comprises receiving the compensation report in coordination with the shared channel repetitions.

In some embodiments, the method may further comprise receiving the compensation report after the shared channel repetitions, wherein the compensation report indicates the at least one adjustment for a previously transmitted reference signal.

In some embodiments, in an instance in which the one or more shared channel repetitions do not fill an allotted time slot for shared channel repetitions, the method may further comprise receiving an acknowledge control channel message indicating the at least one adjustment of the reference signal.

In some embodiments, the compensation report may acknowledge transmission of the reference signal wherein the at least one adjustment has been or will be applied.

In some embodiments, the method may further comprise receiving the compensation report before the shared channel repetitions, wherein the compensation report indicates the at least one adjustment for a future reference signal.

In another embodiment, an apparatus is provided. The apparatus may comprise at least one processor and at least one memory including computer program code, the at least one memory and the computer program code configured to, with the at least one processor, cause the apparatus to: cause information defining a time domain window to be transmitted toward a user equipment, wherein the time domain window indicates a time window in an uplink communication stream in which a reference signal is to be transmitted; receive a compensation report from the user equipment in a control channel message within the uplink communication stream, wherein the compensation report comprises an indication of at least one adjustment to at least one of time or frequency of the reference signal due to a physical characteristic of a transmission environment; and receive the reference signal in an actual time domain window from the user equipment, wherein the actual time domain window is based at least in part on the at least one adjustment.

In some embodiments, the at least one memory and the computer program code may be configured to with the at least one processor, cause the apparatus to receive the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the at least one memory and the computer program code may be configured to with the at least one processor, cause the apparatus to receive the control channel message in accordance with a physical uplink control channel (PUCCH).

In some embodiments, the at least one memory and the computer program code may be configured to with the at least one processor, cause the apparatus to receive the compensation report in a dedicated data field of the control channel message.

In some embodiments, the at least one memory and the computer program code may be configured to with the at least one processor, cause the apparatus to receive the compensation report in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the at least one memory and the computer program code may be configured to with the at least one processor, cause the apparatus to receive the compensation report on a compensation resource set in a control channel message.

In some embodiments, the uplink communication stream may comprise one or more shared channel repetitions and wherein the at least one memory and the computer program code are configured to with the at least one processor, cause the apparatus to receive the compensation report in coordination with the shared channel repetitions.

In some embodiments, the at least one memory and the computer program code may be configured to with the at least one processor, cause the apparatus to receive the compensation report after the shared channel repetitions, wherein the compensation report indicates the at least one adjustment for a previously transmitted reference signal.

In some embodiments, in an instance in which the one or more shared channel repetitions do not fill an allotted time slot for shared channel repetitions, wherein the at least one memory and the computer program code may be configured to with the at least one processor, cause the apparatus to receive an acknowledge control channel message indicating the at least one adjustment of the reference signal.

In some embodiments, the compensation report may acknowledge transmission of the reference signal wherein the at least one adjustment has been or will be applied.

In some embodiments, the at least one memory and the computer program code may be configured to with the at least one processor, cause the apparatus to receive the compensation report before the shared channel repetitions, wherein the compensation report indicates the at least one adjustment for a future reference signal.

In another embodiments, a computer program product is provided. In some embodiments, the computer program product may comprise at least one non-transitory computer-readable storage medium having computer-readable program code portions stored therein, the computer-readable program code portions comprising an executable portion configured to cause information defining a time domain window to be transmitted toward a user equipment, wherein the time domain window indicates a time window in an uplink communication stream in which a reference signal is to be transmitted; receive a compensation report from the user equipment in a control channel message within the uplink communication stream, wherein the compensation report comprises an indication of at least one adjustment to at least one of time or frequency of the reference signal due to a physical characteristic of a transmission environment; and receive the reference signal in an actual time domain window from the user equipment, wherein the actual time domain window is based at least in part on the at least one adjustment.

In some embodiments, the computer program product may be further configured to receive the compensation report comprising compensation information related to at least one of a frequency adjustment and a timing adjustment.

In some embodiments, the physical characteristic of the transmission environment comprises at least one of a transmission medium physical characteristic, a base station physical location, or a user equipment physical location.

In some embodiments, the computer program product may be further configured to receive the control channel message in accordance with a physical uplink control channel (PUCCH).

In some embodiments, the computer program product may be further configured to receive the compensation report in a dedicated data field of the control channel message.

In some embodiments, the computer program product may be further configured to receive the compensation report in a shared data field of the control channel message.

In some embodiments, the shared data field may comprise a base sequence, and wherein the compensation report is encoded by applying a cyclic shift to the base sequence.

In some embodiments, the shared data field may be at least one of a modulation symbol data field or a resource selection data field.

In some embodiments, the computer program product may be further configured to receive the compensation report on a compensation resource set in a control channel message.

In some embodiments, the uplink communication stream may comprise one or more shared channel repetitions and the method further comprises receiving the compensation report in coordination with the shared channel repetitions.

In some embodiments, the computer program product may be further configured to receive the compensation report after the shared channel repetitions, wherein the compensation report indicates the at least one adjustment for a previously transmitted reference signal.

In some embodiments, in an instance in which the one or more shared channel repetitions do not fill an allotted time slot for shared channel repetitions, the method may further comprise receiving an acknowledge control channel message indicating the at least one adjustment of the reference signal.

In some embodiments, the compensation report may acknowledge transmission of the reference signal wherein the at least one adjustment has been or will be applied.

In some embodiments, the computer program product may be further configured to receive the compensation report before the shared channel repetitions, wherein the compensation report indicates the at least one adjustment for a future reference signal.

In another embodiment, an apparatus is provided. In some embodiments, the apparatus may comprise means for causing information defining a time domain window to be transmitted to a user equipment, wherein the time domain window indicates a time window in an uplink communication stream in which a reference signal is to be transmitted; means for receiving a compensation report from the user equipment in a control channel message within the uplink communication stream, wherein the compensation report comprises an indication of at least one adjustment to at least one of time or frequency of the reference signal due to a physical characteristic of a transmission environment; and means for receiving the reference signal in an actual time domain window from the user equipment, wherein the actual time domain window is based at least in part on the at least one adjustment.

In some embodiments, the apparatus may further comprise means for receiving the compensation report comprising compensation information related to at least one of a frequency adjustment and a timing adjustment.

In some embodiments, the physical characteristic of the transmission environment may comprise at least one of a transmission medium physical characteristic, a base station physical location, or a user equipment physical location.

In some embodiments, the apparatus may further comprise means for receiving the control channel message in accordance with a physical uplink control channel (PUCCH).

In some embodiments, the apparatus may further comprise means for receiving the compensation report in a dedicated data field of the control channel message.

In some embodiments, the apparatus may further comprise means for receiving the compensation report in a shared data field of the control channel message.

In some embodiments, the shared data field may comprise a base sequence, wherein the compensation report is encoded by applying a cyclic shift to the base sequence.

In some embodiments, the shared data field may be at least one of a modulation symbol data field or a resource selection data field.

In some embodiments, the apparatus may further comprise means for receiving the compensation report on a compensation resource set in a control channel message.

In some embodiments, the uplink communication stream may comprise one or more shared channel repetitions and the apparatus further comprises means for receiving the compensation report in coordination with the shared channel repetitions.

In some embodiments, the apparatus may further comprise means for receiving the compensation report after the shared channel repetitions, wherein the compensation report indicates the at least one adjustment for a previously transmitted reference signal.

In some embodiments, in an instance in which the one or more shared channel repetitions do not fill an allotted time slot for shared channel repetitions, the apparatus may further comprise means for receiving an acknowledge control channel message indicating the at least one adjustment of the reference signal.

In some embodiments, the compensation report may acknowledge transmission of the reference signal wherein the at least one adjustment has been or will be applied.

In some embodiments, the apparatus may further comprise means for receiving the compensation report before the shared channel repetitions, wherein the compensation report indicates the at least one adjustment for a future reference signal.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a system including user equipment (UE) and a base station, in accordance with an example embodiment of the present disclosure.

FIG. 2 illustrates a block diagram of an apparatus that may be specifically configured in accordance with an example embodiment of the present disclosure.

FIG. 3 illustrates a signal diagram for reporting time and frequency compensation by a UE through an explicit indication, in accordance with an example embodiment of the present disclosure.

FIG. 4 illustrates a signal diagram for reporting time and frequency compensation by a UE through an implicit indication, in accordance with an example embodiment of the present disclosure.

FIG. 5 depicts a graph illustrating cyclical shifts in the frequency domain, in accordance with an example embodiment of the present disclosure.

FIG. 6 illustrates a signal diagram for reporting time and frequency compensation by a UE through an implicit indication with the scheduling request (SR), in accordance with an example embodiment of the present disclosure.

FIG. 7 depicts a graph illustrating transmission of the compensation report in conjunction with a scheduling request, in accordance with an example embodiment of the present disclosure.

FIG. 8 illustrates a signal diagram for reporting time and frequency compensation by transmitting a compensation report in a control channel message preceding the shared channel transmissions, in accordance with an example embodiment of the present disclosure.

FIG. 9 illustrates a signal diagram for reporting time and frequency compensation by transmitting a compensation report in a control channel message following the shared channel transmissions, in accordance with an example embodiment of the present disclosure.

FIG. 10 illustrates a signal diagram for reporting time and frequency compensation by through specific control channel resource sets, in accordance with an example embodiment of the present disclosure.

FIG. 11 illustrates a flow diagram for a process of reporting time and frequency compensation by a UE through a control channel message, in accordance with an example embodiment of the present disclosure.

FIG. 12 illustrates a flow diagram for a process of receiving time and frequency compensation from a UE at a base station through a control channel message, in accordance with an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device. Additionally, as used herein, the term ‘module’ refers to hardware or a combination of hardware and software in which the execution of the software directs operation of the hardware.

### Overview

Various example embodiments address technical problems associated with reporting updates to the time and frequency compensation parameters to a base station. As understood by those of skill in the field to which the present disclosure pertains, there are numerous scenarios in which it may be advantageous to transmit time and frequency compensation parameters to a base station to improve the accuracy and efficiency of data transmission.

As described above, in 5G networks, a demodulation reference signal (DMRS) is utilized to enable reliable and efficient communication between a base station and user equipment (UE) on a physical channel. The DMRS is often transmitted along with transmitted data to provide a reference signal, facilitating more accurate demodulation of the transmitted data. A base station may configure a UE to transmit the DMRS and other data in the nominal (and actual) TDW, wherein the UE must keep phase and power consistency. The DMRS accompanying the transmitted data enables a receiver to determine characteristics of the communication channel which aid the receiver in demodulating the transmitted data.

A DMRS bundling framework has further been introduced to improve the performance of channel estimation, including the performance of joint channel estimation, and provide performance gains in 5G communication. The DMRS bundling framework expands upon the legacy DMRS framework to allow the DMRS to be transmitted across multiple slots coherently. The DMRS bundling framework was introduced to enable improved channel estimation for PUSCH/PUCCH transmissions. Some of the important aspects of DMRS bundling framework are: (1) DMRS bundling may be used for various uplink channel repetition types; (2) a UE can report the maximum duration in number of consecutive slots, during which the UE is able to maintain power consistency and phase continuity; and (3) a base station may configure a nominal TDW, such that the duration of the nominal TDW is shorter than the maximum duration of (2). The maintaining of the power consistency and phase continuity may be subject to a certain tolerance level.

To realize the performance gain of DMRS bundling, several conditions must first be met. For example, the UE may be required to maintain power consistency and phase continuity. Phase continuity must be promised and fulfilled by the UE. Coordination of the duration of the nominal TDW and actual TDW is the mechanism the UE and base station use to ensure both the UE and the base station can determine the slots on the PUSCH are transmitted with DMRS bundled. However, several events may lead to a scenario in which the UE cannot maintain phase continuity. For example, the UE may update the timing advance (TA) of its uplink transmissions based on the location and/or motion of the UE, base station, or another network node.

In current examples, there is no restriction on when or how a timing advance is sent. Incorrect or ignored timing advance adjustments may lead to phase discontinuity and prevent a communication network from operating accurately and efficiently.

The various example embodiments described here utilize various techniques to communicate compensation updates to time and/or frequency parameters of a UE operation. As a result of the herein described example embodiments and in some examples, the accuracy and efficiency of communication between network nodes may be greatly improved.

### System Architecture

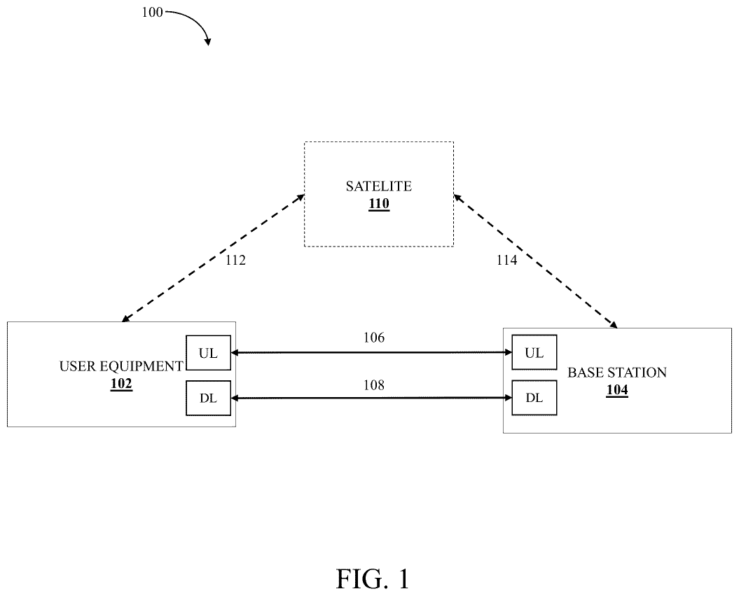

Referring now to FIG. 1, an example communication network 100, such as a 5G network, is provided, within which certain illustrative embodiments are to be implemented. However, it is to be appreciated that embodiments are not limited to the network configurations illustrated herein or otherwise described below. It is to be understood that the elements shown in communication network 100 are intended to represent various functions provided within the system. As such, the blocks shown in FIG. 1 reference specific elements in 5G networks that provide the functions. However, other network elements may be used to implement some or all of the functions represented. Also, it is to be understood that not all functions of a 5G network are depicted in FIG. 1. Rather, functions that facilitate an explanation of illustrative embodiments are represented. Additionally, although described in the context of a 5G network, the reference to a 5G network is by way of example and the method, apparatus and computer program product of other example embodiments may be deployed in other types of networks including legacy networks and networks to be developed, such as sixth generation (6G) or other types of networks.

As depicted in FIG. 1, a UE 102 is communicatively connected to a base station 104. The UE 102 may be configured to transmit control channel messages, such as physical uplink control channel (PUCCH) messages, and data channel messages, such as physical uplink shared channel (PUSCH) messages, on the uplink communication stream 106. In addition, the UE 102 may be configured to receive control channel messages, such as physical downlink control channel (PDCCH) messages, and data channel messages, such as physical downlink shared channel (PDSCH) messages, on the downlink communication stream 108. Further, the UE 102 may be configured to communicate with the base station 104 through non-terrestrial networks, for example, through low earth orbit (LEO) satellites (e.g., satellite 110).

FIG. 1 depicts a communication network 100. By way of example, the communication network 100 may be deployed within a radio access architecture. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access network eligible to access the 5G core network such as an Un-trusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the base station.

As further depicted in FIG. 1, the example communication network 100 may include one or more UEs 102, as shown, the one or more UEs 102 may communicate, with a base station 104, such as via a wireless interface. The UE 102 may be a mobile station, and such a mobile station may comprise a location and velocity. The UE 102 may be equipped with functionality that can provide the UE 102 its geo-location, for example, through the Global Navigation Satellite System (GNSS). For example by utilizing a global positioning system (GPS), GloNass, Gallileo or other similar geo-location systems.

The term “user equipment” as used herein is intended to be construed broadly, so as to encompass a variety of different types of mobile stations, subscriber stations or, more generally, communication devices. In addition to or instead of those identified above, the UE 102 may also refer to a portable computing device that includes wireless mobile communication devices operating with or without a subscriber identification module (SIM), including, but not limited to, the following types of devices: a mobile station (mobile phone), smartphone, personal digital assistant (PDA), vehicle, UE mounted on a vehicle, internet of thing (IoT) device, wearable device, handset, device using a wireless modem (alarm or measurement device, etc.), laptop and/or touch screen computer, tablet, game console, notebook, and multimedia device. The UE 102 may also be called a subscriber unit, mobile station, remote terminal, access terminal, user terminal or user device just to mention but a few apparatuses.

FIG. 1 further depicts a base station 104 communicatively connected to a UE 102. In the radio access architecture of FIG. 1, UE 102 is configured to be in a wireless connection on one or more communication channels in a cell with a base station 104, such as a next generation Node B (gNB). The physical link from a UE 102 to a base station 104 is called the uplink or reverse link (e.g., uplink communication system 106) and the physical link from the base station 104 to the UE 102 is called the downlink or forward link (e.g., downlink communication system 108). It should be appreciated that the base stations 104 or their functionalities may be implemented by using any node, host, server, access point (AP), or other entity suitable for such a usage.

A communication network 100 typically comprises more than one base station 104, in which case the base stations 104 may also be configured to communicate with one another over links, wired or wireless, designed for that purpose. The base station 104 may also be referred to as a gNB, an access point, or any other type of interfacing device including a relay station capable of operating in a wireless environment. The base station 104 includes or is coupled to transceiver(s). From the transceivers of the base station 104, a connection is provided to an antenna unit that establishes bi-directional radio links to the UE 102. As such, the transceivers of the base station 104 and the transceivers of the UE 102 may include transmitters and receivers configured to communicate via a channel.

As further depicted in FIG. 1, a communication network 100 may include an uplink communication system 106. An uplink communication system 106 may comprise a plurality of communication channels, for example, a PUSCH and a PUCCH, enabling communication from the UE 102 to the base station 104. The PUSCH transmission(s) from a UE 102 may be dynamically scheduled by a base station 104 via an uplink grant indicated in the downlink communication stream 108 (e.g., PDCCH). In addition, The PUSCH transmission(s) from a UE 102 may be semi-persistently and/or statically scheduled with a higher layer configured grant, such as configuredGrantConfig.

The PUCCH transmissions may be used to provide uplink control information (UCI) from the UE 102 to the base station 104. Such UCI can cover channel quality information (CQI), channel state information (CSI), information related to the downlink transmissions, for example hybrid automatic repeat request acknowledgements (HARQ-ACK), and other control information. The various types of UCI carried on the PUCCH may be multiplexed or transmitted as standalone information. As such, the payload size that is transmitted on the PUCCH may be a time-varying, yet deterministic size for the base station 104 to decode when receiving.

As further depicted in FIG. 1, the communication network 100 may include non-terrestrial networks (NTNs) using one or more satellites (e.g., satellite 110). Communication networks 100 defined in accordance with the third generation partnership project (3GPP) may support communication between satellites 110 and UEs 102. Communication between satellites 110 and UEs 102 introduce unique challenges. For example, satellites 110 may move at high speeds (7500 m/s at low earth orbit) and potentially having extremely long round trip times (due to satellites being at 36000 km altitude for geostationary/geosynchronous orbits, which causes a round trip time of approximately 0.5 seconds). In some embodiments, the satellites 110 used for communicating with the UEs 102 may be operating in “transparent mode,” meaning the satellites 110 may behave as mobile remote radio heads in communication with a traditional base station 104 located on earth. In some embodiments, the satellites 110 used for communicating with the UEs 102 may be operating in “regenerative mode,” meaning the functionality of the base station 104 may be at least partially implemented on the satellite 110.

As depicted in FIG. 1, a first communication link (e.g., service link 112) is established between the UE 102 and the satellite 110 and a second communication link (e.g., feeder link 114) is established between the satellite 110 and the base station 104.

One of the primary challenges in the communication with a satellite 110, is that satellites in LEO are moving at high velocity, thereby causing the path distance for both the feeder link 114 and the service link 112 to change with time. In order to facilitate accurate and efficient transmission of data through the service link 112, the UE 102 may receive the satellite's 110 position and velocity. Knowing the satellite's 110 position and velocity enables the UE 102 to determine impairments in the service link 112 and the doppler effect experienced by the movement of the satellite 110 and/or the movement of the UE 102. Thus, the UE 102 may determine a time adjustment that may be applied to the transmitted and/or received signals to compensate for the motion of the UE 102 and/or the satellite 110. Similarly, the base station 104 may determine a time variation for signals transmitted on the feeder link 114 between the satellite 110 and the base station 104. Time adjustments applicable to the feeder link 114 are known as common TA parameters, since these time adjustments apply to all UEs 102 utilizing the satellite 110. Common TA parameters may be used by the UE 102 to perform additional compensation to the transmitted signal based on impairments applicable on the feeder link 114. Due to the dynamic nature of an NTN communication system, additional parameters are provided to ensure the accuracy of received data. For example, and epoch time may accompany a data transmission. Epoch time defines the time within which the transmitted information is to be considered valid. The epoch time enables the UE to determine the validity of the satellite's 110 position at a given time.

In addition, a validity timer may accompany a data transmission. A validity timer may be transmitted by a base station 104 informing the UE 102 for how long after the epoch time the UE 102 may consider the ephemeris information of the satellite 110 to be applicable. The validity timer ensures the UE 102 is not using information that is outside of the “prediction horizon.”

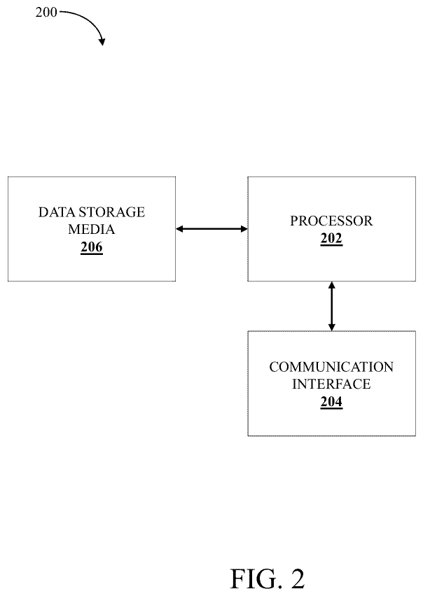

Referring now to FIG. 2, FIG. 2 illustrates an example network node 200 in accordance with at least some example embodiments of the present disclosure. The example network node 200 includes processor 202, communication interface 204, and data storage media 206. The example network node 200 may, in some embodiments, be embodied in various computing devices as described above, for example, the UE 102, the base station 104, and the satellite 110.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the network node 200 provide or supplement the functionality of other particular sets of circuitry. For example, the processor 202 in some embodiments provides processing functionality to any of the sets of circuitry, the data storage media 206 provides storage functionality to any of the sets of circuitry, the communication interface 204 provides network interface functionality to any of the sets of circuitry, and/or the like.

In some embodiments, the processor 202 (and/or co-processor or any other processing circuitry assisting or otherwise associated with the processor) is/are in communication with the data storage media 206 via a bus for passing information among components of the network node 200. In some embodiments, for example, the data storage media 206 is non-transitory and may include, for example, one or more volatile and/or non-volatile memories. In other words, for example, the data storage media 206 in some embodiments includes or embodies an electronic storage device (e.g., a computer readable storage medium). In some embodiments, the data storage media 206 is configured to store information, data, content, applications, instructions, or the like, for enabling the network node 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the network node 200, and/or one or more remote or “cloud” processor(s) external to the network node 200.

In an example embodiment, the processor 202 is configured to execute instructions stored in the data storage media 206 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

In some embodiments, the network node 200 includes communication interface 204. The communication interface 204 includes any means such as a device or circuitry embodied in either hardware or a combination of hardware and software that is configured to receive and/or transmit data from/to a network and/or any other device, circuitry, or module in communication with the network node 200. In this regard, the communication interface 204 includes, for example in some embodiments, a network interface for enabling communications with a wired or wireless communications network. Additionally or alternatively in some embodiments, the communication interface 204 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communication interface 204 includes circuitry for interacting with the antenna(s) and/or other hardware or software to cause transmission of signals via the antenna(s) or to handle receipt of signals received via the antenna(s). In some embodiments, the communication interface 204 enables transmission to and/or receipt of data from a client device in communication with the network node 200.

Additionally or alternatively, in some embodiments, one or more of the sets of circuitry 202-206 are combinable. Additionally or alternatively, in some embodiments, one or more of the sets of circuitry perform some or all of the functionality described associated with another component. For example, in some embodiments, one or more sets of circuitry 202-206 are combined into a single module embodied in hardware, software, firmware, and/or a combination thereof.

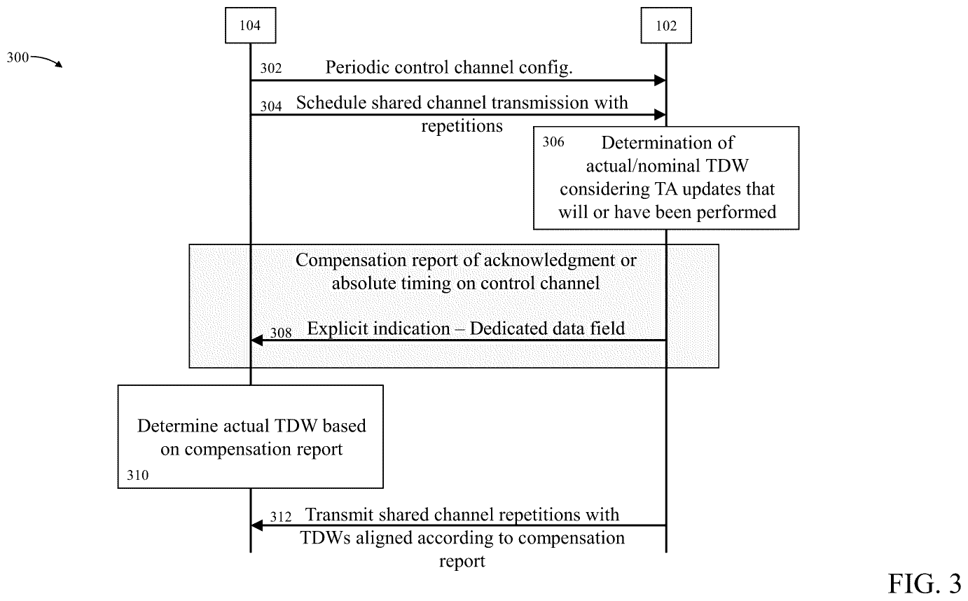

Referring now to FIG. 3, a signal diagram depicting a process 300 for providing a compensation report to a base station 104 is provided. As depicted in FIG. 3, signal 302 transmitted by the base station 104 configures the UE 102 for transmission of periodic control channel message transmissions. Periodic control channel message transmissions may be any transmission mode in which the control channel message comprising uplink control information (UCI) is transmitted by the UE 102 at a pre-determined time interval, rather than being transmitted immediately in response to a downlink control message. In some embodiments, the control channel message may be a PUCCH message. Configuration of the periodic PUCCH may include parameters such as the format for transmitting control information, a resource index, the hopping mode, the power offset, the channel quality indicator (CQI) reporting configuration, and other transmission parameters.

The base station 104 may additionally configure the UE 102 to transmit DMRS according to a DMRS bundling framework. Utilizing a DMRS on the uplink channels may ensure accurate and reliable data transmissions. In some embodiments, a DMRS may be transmitted according to a DMRS bundling framework. The DMRS bundling framework was introduced to enable improved channel estimation for PUSCH and PUCCH transmissions. A primary objective of the DMRS bundling framework is to ensure that the base station 104 and UE 102 coordinate the number of slots wherein DMRS bundling is applied. Thus, utilizing signal 302, the base station may configure the nominal and actual TDW of the UE 102 for DMRS bundling. DMRS bundling specifies a time domain window (TDW), within which the UE must maintain the power consistency and phase continuity across the PUSCH/PUCCH transmission, including the corresponding DMRS symbols. The TDW determination includes two steps, nominal TDW determination and actual TDW determination.

As it relates to TDW within the DMRS bundling framework, the 5G technical reference produced by 3^{rd} Generation Partnership Project (3GPP) indicates for PUSCH transmissions of PUSCH repetition Type A scheduled by DCI format 0_1 or 0_2, PUSCH repetition Type A with a configured grant, PUSCH repetition Type B and TB processing over multiple slots, when PUSCH-DMRS-Bundling is enabled, and for PUCCH transmissions of PUCCH repetition, when PUCCH-DMRS-Bundling is enabled, the UE determines one or multiple nominal TDWs, as follows: for PUSCH transmissions of repetition Type A, PUSCH repetition Type B and TB processing over multiple slots, the duration of each nominal TDW except the last nominal TDW, in number of consecutive slots, is: (a) given by PUSCH-TimeDomainWindowLength, if configured; (b) computed as min ([maxDMRS-BundlingDuration], M), if PUSCH-TimcDomainWindowLength is not configured, where [maxDMRS-BundlingDuration] is maximum duration for a nominal TDW subject to UE capability [13, TS 38.306], M is the time duration in consecutive slots of N·K PUSCH transmissions, and where (i) for PUSCH transmissions of PUSCH repetition Type A, N=1 and K is the number of repetitions, as defined in Clause 6.1.2.1 or in Clause 6.1.2.3 of TS 38.214; (ii) for PUSCH transmissions of PUSCH repetition Type B, N=1 and K is the number of nominal repetitions, as defined in Clause 6.1.2.1 or in Clause 6.1.2.3 of TS 38.214; and (iii) for PUSCH transmissions of TB processing over multiple slots, N is the number of slots used for TBS determination and K is the number of repetitions of the number of slots N used for TBS determination, as defined in Clause 6.1.2.1 or in Clause 6.1.2.3 of TS 38.214.

As it relates to Nominal TDW within the DMRS bundling framework, the 5G technical reference produced by 3GPP indicates: (1) For PUSCH transmission of a PUSCH repetition Type A scheduled by DCI format 0_1 or 0_2 and PUSCH repetition Type A with a configured grant, when AvailableSlotCounting is enabled, and for TB processing over multiple slots: (a) the start of the first nominal TDW is the first slot determined for the first PUSCH transmission; (b) the end of the last nominal TDW is the last slot determined for the last PUSCH transmission; and (c) the start of any other nominal TDWs is the first slot determined for PUSCH transmission after the last slot determined for PUSCH transmission of a previous nominal TDW; and (2) for PUSCH transmissions of a PUSCH repetition type A scheduled by DCI format 0_1 or 0_2 and PUSCH repetition Type A with a configured grant, when the UE is not configured with AvailableSlotCounting or when AvailableSlotCounting is disabled, and for PUSCH repetition type B: (a) the start of the first nominal TDW is the first slot for the first PUSCH transmission; (b) the end of the last nominal TDW is the last slot for the last PUSCH transmission; and (c) the start of any other nominal TDWs is the first slot after the last slot of a previous nominal TDW.

As it relates to the determination of Actual TDWs within the DMRS bundling framework, the 5G technical reference produced by 3GPP indicates: for PUSCH transmissions of a PUSCH repetition Type A scheduled by DCI format 0_1 or 0_2, PUSCH repetition Type A with a configured grant, PUSCH repetition Type B and TB processing over multiple slots, a nominal TDW consists of one or multiple actual TDWs. The UE determines the actual TDWs as follows: (1) the start of the first actual TDW is the first symbol of the first PUSCH transmission in a slot for PUSCH transmission of PUSCH repetition type A scheduled by DCI format 0_1 or 0_2, or PUSCH repetition Type A with a configured grant, or PUSCH repetition type B or TB processing over multiple slots within the nominal TDW; (2) the end of an actual TDW is: (a) the last symbol of the last PUSCH transmission in a slot for PUSCH transmission of PUSCH repetition type A scheduled by DCI format 0_1 or 0_2, or PUSCH repetition Type A with a configured grant, or PUSCH repetition type B or TB processing over multiple slots within the nominal TDW, if the actual TDW reaches the end of the last PUSCH transmission within the nominal TDW; (b) the last symbol of a PUSCH transmission before the event, if an event occurs which causes power consistency and phase continuity not to be maintained across PUSCH transmissions of PUSCH repetition type A scheduled by DCI format 0_1 or 0_2, or PUSCH repetition Type A with a configured grant, or PUSCH repetition type B or TB processing over multiple slots within the nominal TDW, and the PUSCH transmission is in a slot for PUSCH transmission of PUSCH repetition type A scheduled by DCI format 0_1 or 0_2, or PUSCH repetition Type A with a configured grant, or PUSCH repetition type B or TB processing over multiple slots; or (c) when PUSCH-Window-Restart is enabled, the start of a new actual TDW is the first symbol of the PUSCH transmission after the event which causes power consistency and phase continuity not to be maintained across PUSCH transmissions of PUSCH repetition type A scheduled by DCI format 0_1 or 0_2, or PUSCH repetition Type A with a configured grant, or PUSCH repetition type B or TB processing over multiple slots within the nominal TDW, and the PUSCH transmission is in a slot for PUSCH transmission of PUSCH repetition type A scheduled by DCI format 0_1 or 0_2, or PUSCH repetition Type A with a configured grant, or PUSCH repetition type B or TB processing over multiple slots.

In one example embodiment, the base station 104 may configure the UE 102 with periodic PUCCH transmissions. For example, the periodic configuration of PUCCH can be accomplished via a scheduling request (SR) configuration (e.g., “SchedulingRequestResourceConfig”) and a radio resource control (RRC) parameter (e.g., “periodicityAndOffset”). In one embodiment, the RRC parameter (e.g., “periodicityAndOffset”) may be in the symbol or slot duration with different range values for different subcarrier spacing. As an example, the subcarrier spacing may be 15 kilohertz and the periodicity 160 slots.

As further depicted in FIG. 3, signal 304 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling may be especially useful for PUSCH transmissions with repetition. DMRS bundling transmits DMRSs associated with PUSCH transmission repetitions coherently. In an instance in which multiple PUSCH messages are transmitted as part of a PUSCH repetition framework, and each PUSCH transmission is further configured with DMRS bundling, the DMRSs of multiple transmissions may be processed jointly rather than separately to provide additional transmission improvements on top of the transmission improvements realized by repetition.

As further depicted in FIG. 3, at block 306, the UE 102 determines pre-compensation timing and actual TDWs. Certain events may occur within a communication network 102 which prevent the UE 102 from maintaining phase continuity as required for DMRS bundling. For example, a UE 102 may perform an update of the timing advance (TA) value. At block 306, UE 102 determines the points in time where it expects to perform an update of the TA value, or where it performed an update of the TA value. In the first case, the determination may occur before the start of the nominal/actual TDW whereas in the second case after the end of the nominal/actual TDW. In another embodiment, UE 102 determines the points in time where it performs an update of the TA value. A TA is a mechanism used to compensate for differences in the time it takes for the uplink signal to travel from the UE 102 to the base station. A TA may be based on the distance between the UE 102 and the base station 104. As described herein, a TA may be necessary when communication from a UE 102 to a base station 104 passes through satellite 110. In such an instance, the TA may account for the common TA on the feeder link 114 and the UE 102 specific TA on the service link 112. Based on any TA updates, the UE 102 may further determine the actual TDWs within the nominal TDW.

An actual time domain window may be any time domain window resulting from one or more adjustments to the time and/or frequency within the nominal time domain window for data transmission, for example, the uplink time domain window configured by the base station 104 for the UE 102. In some embodiments, adjustments to the time domain window resulting in an actual time domain window may be the result of an event causing a discontinuity in the phase of channels transmitting portions of the DMRS. For example, a TA update may result in an adjustment to the time domain window and the determination of an actual time domain window. Adjustments to the time domain window may include but are not limited to time shifts, phase shifts, frequency changes, and other similar adjustments. In some embodiments, the actual time domain window may be determined based on one or more physical characteristics of the transmission environment. Physical characteristics of the transmission environment may include a physical characteristic of the transmission medium, such as attenuation, refraction, reflection, absorption, and/or other signal attenuation effects caused by the transmission medium. The physical location of the base station 104 and the UE 102 may also effect the compensation that may be applied to the time domain window, such as the distance between the UE 102 and the base station 104. The physical layout of the communication network may be another physical characteristic of the transmission environment that may affect the compensation applied to the time domain window. For example, if the UE 102 communicates through a satellite 110 in an NTN, the distance traveled and the speed of the satellite 110 and/or the UE 102 may affect the compensation applied to the actual time domain window.

As further depicted in FIG. 3, signal 308 transmitted by the UE 102 either reports the acknowledgment of the UE 102 uplink time/frequency compensation to the base station 104 to indicate to the base station 104 the successful TA update or reports the planned or the performed TA update instance(s) by providing a compensation report. A compensation report may be any indication of the planned or executed time instances where adjustment to the TA occurs or has occurred. In some embodiments, the compensation report may comprise a mechanism for indicating to the base station 104 that a timing/frequency adjustment has been applied. For example, the compensation report may acknowledge and/or indicate that a timing adjustment has been received and applied. In such an embodiment, the compensation report may be a Boolean indicator. In some embodiments, the compensation report may provide the absolute timing, indicating in milliseconds or slots the timing/frequency adjustment has been made. In such an embodiment, the compensation report may comprise multiple data bits and/or fields to convey the absolute timing. In some embodiments, the compensation report may include an actual time domain window, information for determining the actual time domain window, and/or information for determining the actual time domain window based on the provided time domain window (e.g., offsets). In some embodiments, the compensation report may be in the form of an acknowledgment that the UE 102 has successfully performed the time/frequency compensation on the transmitted data. An acknowledgement may indicate that an adjustment to the TDW has been made, but may not necessarily indicate the precise timing of the TDW. An acknowledgment from the UE 102 may be sufficient for the base station to understand the capability of the UE 102 in maintaining phase continuity and power consistency for a certain duration of time in the future, however, the precise timing of the adjustments may not be communicated. In this way, an acknowledgement may not provide flexibility in the compensation report but may utilize less overhead. In some embodiments, the compensation report may be transmitted after the time/frequency adjustments have been made. For example, the compensation report may be transmitted to the base station 104 providing an acknowledgment of time/frequency compensation after the data has been transmitted to the base station 104. In some embodiments, the compensation report may be transmitted to the base station 104 previous to the transmission of data in accordance with the actual time domain window.

As depicted in FIG. 3, one example mechanism for transmitting the compensation report may include the UE 102 explicitly indicating the compensation report to the base station 104 via a dedicated data field. A dedicated data field may be any bit or sequence of bits utilized primarily for indicating the compensation report. For example, a new data field transmitted in a control channel message (e.g., PUCCH) within the uplink communication stream (e.g., uplink communication stream 106) may be allocated. In some embodiments, the compensation report may indicate acknowledgement by a new bit field, for example utilizing a new bit field comprising 1 bit, in which a 1 indicates acknowledgement that the time/frequency compensation has been performed. In some embodiments, the compensation report may indicate absolute timing (e.g., in milliseconds or slots) or relative timing, for example relative to the start of the nominal TDW in milliseconds or slots, of the time and frequency compensation. In such an embodiment, a plurality of bits may be utilized to indicate an absolute time/frequency, and/or an offset time/frequency.

As further depicted in FIG. 3, at block 310 the base station 104 may receive the compensation report including the timing and/or frequency adjustments within the time domain window such that the instances of time when the compensation is performed window may be determined. The base station 104 may determine the actual TDWs within the configured nominal TDW for a UE 102 transmission on the uplink communication stream 106 based on the compensation report.

As further depicted in FIG. 3, signal 312 transmitted by the UE 102 may transmit PUSCH and/or PUCCH transmissions with repetitions and with the actual TDWs adjusted according to the determined time instances of time/frequency compensation. In addition, the base station 104 may receive the PUSCH and/or PUCCH transmissions and demodulate the DMRS according to the actual time domain window.

In some embodiments, the shared channel repetitions (e.g., PUSCH repetitions) do not fill a time slot allotted for transmission of the shared channel repetition. In such an instance, a time space may exist between the transmission of a first shared channel repetition and a second shared channel transmission. In such an instance, a control channel message (e.g., PUCCH) may be transmitted in the time gap between the transmission of the first shared channel repetition and the second shared channel repetition. In such an embodiment, the UE 102 may transmit the compensation report on the control channel message between transmissions of the shared channel repetitions. In some embodiments, the compensation report may indicate the compensation time instances of the shared channel repetition previously transmitted. In some embodiments, the compensation report may indicate the compensation time instances for an upcoming shared channel repetition. In some embodiments, the compensation report may indicate the successful compensation in the form of an acknowledgment.

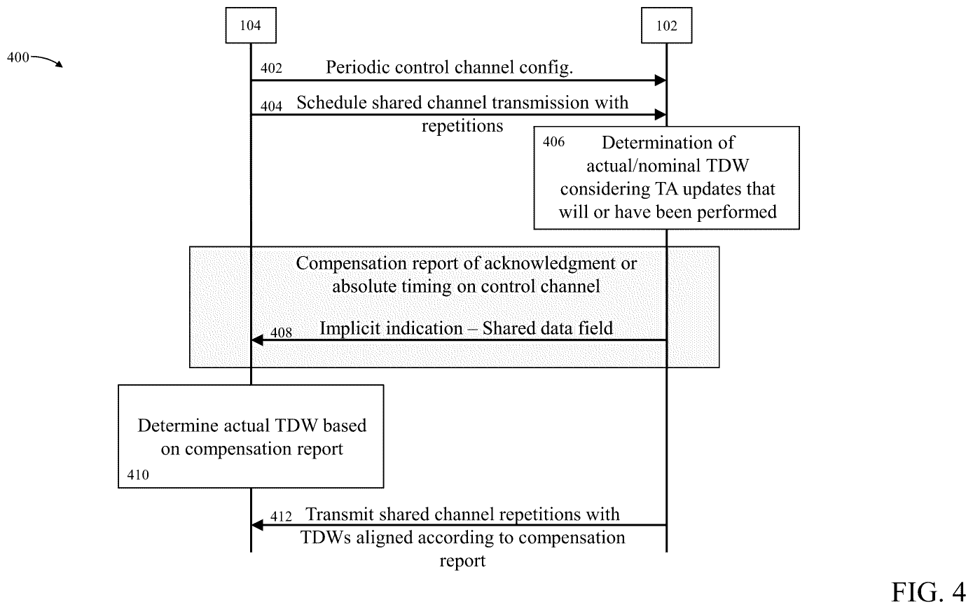

Referring now to FIG. 4, a signal diagram depicting a process 400 for providing a compensation report to a base station 104 is provided. As depicted in FIG. 4, signal 402 as transmitted by the base station 104 configures the UE 102 for transmission of periodic control channel message transmissions. Periodic control channel message transmissions may be any transmission mode in which the control channel message comprising uplink control information (UCI) is transmitted by the UE 102 at a pre-determined time interval, rather than being transmitted immediately in response to a downlink control message. In some embodiments, the periodic control channel message transmissions may comprise PUCCH messages. Configuration of the periodic PUCCH may include parameters such as the format for transmitting control information, a resource index, the hopping mode, the power offset, the channel quality indicator (CQI) reporting configuration, DMRS bundling framework parameters, and other transmission parameters.

In one example embodiment, the base station 104 may configure the UE 102 with periodic PUCCH transmissions. For example, the periodic configuration of PUCCH can be accomplished via a scheduling (SR) configuration request (e.g., “SchedulingRequestResourceConfig”) and a radio resource control (RRC) parameter (e.g., “periodicityAndOffset”). In one embodiment, the RRC parameter (e.g., “periodicityAndOffset”) may be in the symbol or slot duration with different range values for different subcarrier spacing. As an example, the subcarrier spacing may be 15 kilohertz and the periodicity 160 slots.

As further depicted in FIG. 4, signal 404 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling transmits DMRSs associated with PUSCH transmission repetitions coherently. In an instance in which multiple PUSCH messages are transmitted as part of a PUSCH repetition framework, and each PUSCH transmission is further configured with DMRS bundling, the DMRSs of multiple transmissions may be processed jointly rather than separately to provide additional transmission improvements on top of the transmission improvements realized by repetition.

As further depicted in FIG. 4, at block 406 the UE 102 determines pre-compensation timing and actual TDWs. Certain events may occur within a communication network 102 which prevent the UE 102 from maintaining phase continuity as required for DMRS bundling. Based on any TA updates, the UE 102 may further determine the actual TDWs within the nominal TDW. An actual time domain window may be any time domain window resulting from one or more adjustments to the time and/or frequency within the nominal TDW, for example, the uplink time domain window configured by the base station 104 for the UE 102. In some embodiments, adjustments to the time domain window resulting in an actual time domain window may be the result of an event causing a discontinuity in the phase of channels transmitting portions of the DMRS. For example, a TA update may result in an adjustment to the time domain window and the determination of an actual time domain window. Adjustments to the time domain window may include but are not limited to time shifts, phase shifts, frequency changes, and other similar adjustments.

As further depicted in FIG. 4, the UE 102 transmits the signal 408 to report the acknowledgment of the UE 102 uplink time/frequency compensation to the base station 104 to indicate to the base station 104 the successful or planned TA update instances by providing a compensation report. A compensation report may be any indication of a planned or executed adjustment to the time domain window. In some embodiments, the compensation report may include an actual time domain window, information for determining the actual time domain window, and/or information for determining the actual time domain window based on the provided time domain window (e.g., offsets).

As further depicted in FIG. 4 one example mechanism for transmitting the compensation report may include the UE 102 implicitly indicating the compensation report through a shared data field in the control channel message. A shared data field may be any bit, sequence of bits, or other data field in a control channel message at least partially allocated for other purposes aside from transmitting the compensation report, for example, an existing data field in the PUCCH. As one example, the UE 102 may transmit the compensation report by applying a specific cyclic shift to the PUCCCH sequence used for transmitting the compensation report. IN some embodiments, the PUCCH could be PUCCH format 0. For example, in PUCCH format 0, information is conveyed via applying different cyclic shifts to a base sequence of length 12 as follows:

$$r ( n ) = {e}^{j α n} \times k ( n ) , \qquad 0 \leq n < 12$$

where k(n) denotes the base sequence, and the term e^{jan} provides the frequency domain phase shift to the base sequence. More particularly, α is calculated as follows:

$$α = \frac{2 π}{12} [ ( {m}_{0} + {m}_{c s} + p ) mod 12 ] ,$$

where m₀ is the initial cyclic shift, p is a function based on a pseudo random sequence, and m_{cs} transfers the information content of UCI. Thus, different values of m_{cs} (and subsequently different values of α) determine the information content of UCI. The term α can take values of

$$\{ 0 , 1 , 2 , 3 , … , 11 \} \times \frac{2 π}{12} .$$

However, in some embodiments, values of

$$α = \{ 2 , 5 , 8 , 11 \} \times \frac{2 π}{12}$$

are reserved and are not used to apply cyclic shifts to the base sequence. Thus, α={2, 5, 8, 11} may be exploited to carry the compensation report, for example, asserting a specific value of the cyclic shift parameter may be an indicator of the compensation report for acknowledgment.

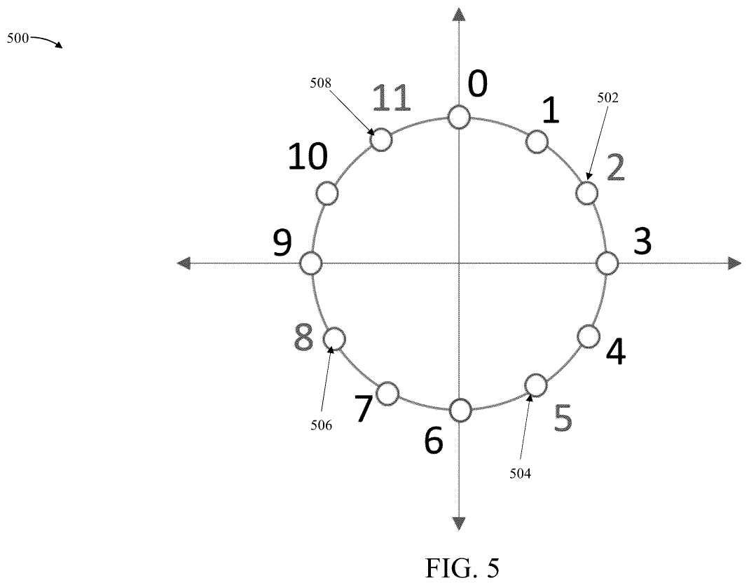

FIG. 5 illustrates an example cyclical shift graph 500 used to encode UCI data on the PUCCH. As indicated herein, certain cyclical shift values may be unused, for example, 502, 504, 506, and 508. The available cyclical shift values may be utilized to encode a compensation report acknowledging successful time/frequency compensation.

As depicted in FIG. 4, at block 410, the base station 104 may receive the compensation report including the timing and/or frequency adjustments within the time domain window in the shared data field such that the instances of time when the compensation is performed may be determined. The base station 104 may determine the actual TDWs within the configured nominal TDW for a UE 102 transmission on the uplink communication stream 106 based on the compensation report.

As further depicted in FIG. 4, signal 412 transmitted by the UE 102 may transmit PUSCH and/or PUCCH transmissions with repetitions and with the actual TDWs adjusted according to the determined time instances of time/frequency compensation. In addition, the base station 104 may receive the PUSCH and/or PUCCH transmissions and demodulate the DMRS according to the actual time domain window.

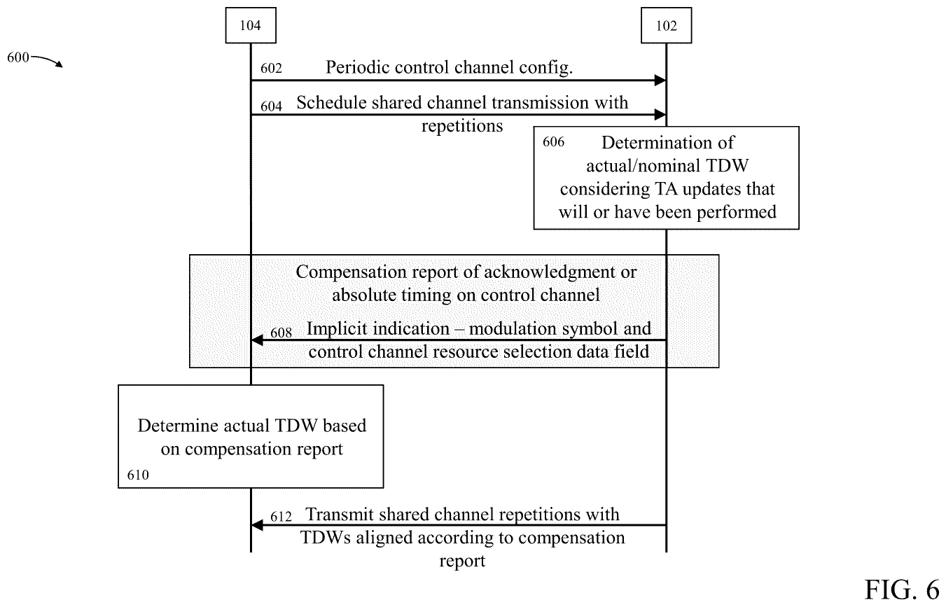

Referring now to FIG. 6, a signal diagram depicting a process 600 for providing a compensation report to a base station 104 is provided. As depicted in FIG. 6, signal 602 transmitted by the base station 104 configures the UE 102 for transmission of periodic control channel message transmissions. Periodic control channel message transmissions may be any transmission mode in which the control channel message comprising uplink control information (UCI) is transmitted by the UE 102 at a pre-determined time interval, rather than being transmitted immediately in response to a downlink control message. In some embodiments, the periodic control channel message transmissions may comprise PUCCH messages. Configuration of the periodic PUCCH may include parameters such as the format for transmitting control information, a resource index, the hopping mode, the power offset, the channel quality indicator (CQI) reporting configuration, DMRS bundling framework parameters, and other transmission parameters.

In one example embodiment, the base station 104 may configure the UE 102 with periodic PUCCH transmissions. For example, the periodic configuration of PUCCH can be accomplished via a scheduling request (SR) configuration (e.g., “SchedulingRequestResourceConfig”) and a radio resource control (RRC) parameter (e.g., “periodicity AndOffset”). In one embodiment, the RRC parameter (e.g., “periodicityAndOffset”) may be in the symbol or slot duration with different range values for different subcarrier spacing. As an example, the subcarrier spacing may be 15 kilohertz and the periodicity 160 slots.

As further depicted in FIG. 6, signal 604 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling transmits DMRSs associated with PUSCH transmission repetitions coherently. In an instance in which multiple PUSCH messages are transmitted as part of a PUSCH repetition framework, and each PUSCH transmission is further configured with DMRS bundling, the DMRSs of multiple transmissions may be processed jointly rather than separately to provide additional transmission improvements on top of the transmission improvements realized by repetition.

As further depicted in FIG. 6, at block 606, the UE 102 determines pre-compensation timing and actual TDWs. Certain events may occur within a communication network 102 which prevent the UE 102 from maintaining phase continuity as required for DMRS bundling. Based on any TA updates, the UE 102 may further determine the actual TDWs within the nominal TDW. An actual time domain window may be any time domain window resulting from one or more adjustments to the time and/or frequency within the nominal TDW, for example, the uplink time domain window configured by the base station 104 for the UE 102. In some embodiments, adjustments to the time domain window resulting in an actual time domain window may be the result of an event causing a discontinuity in the phase of channels transmitting portions of the DMRS. For example, a TA update may result in an adjustment to the time domain window and the determination of an actual time domain window. Adjustments to the time domain window may include but are not limited to time shifts, phase shifts, frequency changes, and other similar adjustments.

As further depicted in FIG. 6, signal 608 transmitted by the UE 102 either reports the acknowledgment of the UE 102 uplink time/frequency compensation to the base station 104 to indicate to the base station 104 the successful TA update or reports the planned or the performed TA update instance(s) by providing a compensation report. A compensation report may be any indication of the planned or executed time instances where adjustment to the TA occurs or has occurred. In some embodiments, the compensation report may include an actual time domain window, information for determining the actual time domain window, and/or information for determining the actual time domain window based on the provided time domain window (e.g., offsets).

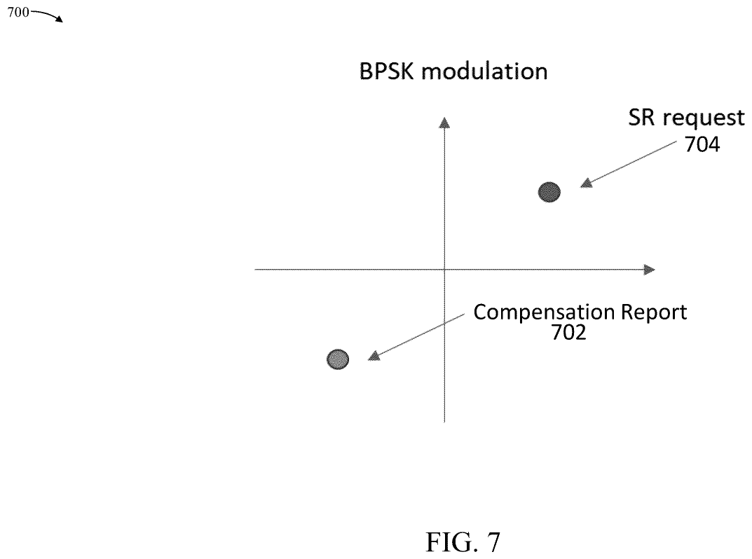

As further depicted in FIG. 6, one example mechanism for transmitting the compensation report may include using a shared data field. As indicated herein, a shared data field may be any bit, sequence of bits, or other data field in a control channel message at least partially allocated for purposes aside from transmitting the compensation report, for example, an existing data field in the PUCCH. As one example, the UE 102 may transmit the compensation report utilizing the combination of a modulation symbol and control channel time/frequency resources. Particularly, in conjunction with PUCCH format 1, the UE 102 may transmit the compensation report using the scheduling request (SR) data field and the HARQ-ACK data field. In some embodiments, PUCCH format 1 is used to carry one or two ACK/NACK and/or SR symbols. When only SR is transmitted (e.g., it is not carried concurrently with HARQ ACK/NACK), the SR is carried by a π/2 binary phase shift keying (BPSK) modulation. In some embodiments, it may be specified that for sending SR only, the information bit is set to a default value of 0 (e.g., mapped to BPSK symbol (+1)). By utilizing the SR resource, the presence of a compensation report may be indicated by setting the information bit on the SR resource to a value of 1 (e.g., mapped to BPSK symbol (−1)) as shown in FIG. 6. Thus, as shown in FIG. 7, the compensation report 702 may be transmitted on a different BPSK modulation scheme than the SR request 704.

As further depicted in FIG. 6, at block 610, the base station 104 may receive the compensation report including the timing and/or frequency adjustments within the time domain window in the shared data field such that the instances of time when the compensation is performed may be determined. The base station 104 may determine the actual TDWs within the configured nominal TDW for a UE 102 transmission on the uplink communication stream 106 based on the compensation report.

As further depicted in FIG. 6, signal 612 transmitted by the UE 102 may transmit PUSCH and/or PUCCH transmissions with repetitions and with the actual TDWs adjusted according to the determined time instances of time/frequency compensation. In addition, the base station 104 may receive the PUSCH and/or PUCCH transmissions and demodulate the DMRS according to the actual TDW.

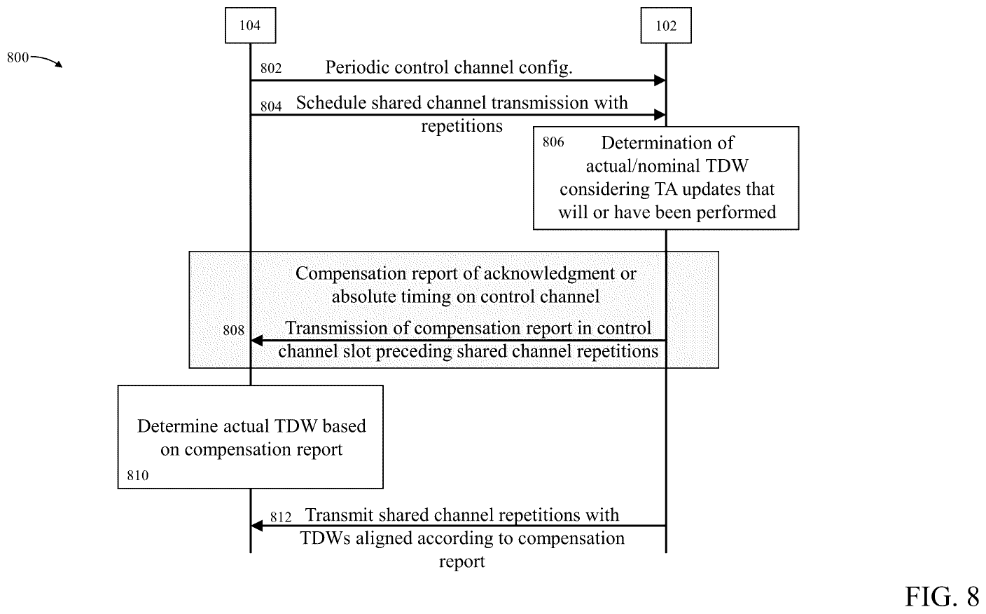

Referring now to FIG. 8, a signal diagram depicting a process 800 for providing a compensation report to a base station 104 is provided. As depicted in FIG. 8, signal 802 transmitted by the base station 104 configures the UE 102 for transmission of periodic control channel message transmissions. In some embodiments, the periodic control channel message transmissions may comprise PUCCH messages.

As further depicted in FIG. 8, signal 804 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling may be especially useful for PUSCH transmissions with repetition.

As further depicted in FIG. 8, at block 806, the UE 102 determines pre-compensation timing and actual TDWs. Certain events may occur within a communication network 102 which prevent the UE 102 from maintaining phase continuity as required for DMRS bundling. Based on any TA updates, the UE 102 may further determine the actual TDWs within the nominal TDW. An actual time domain window may be any time domain window resulting from one or more adjustments to the time and/or frequency within the nominal TDW, for example, the uplink time domain window configured by the base station 104 for the UE 102. In some embodiments, adjustments to the time domain window resulting in an actual time domain window may be the result of an event causing a discontinuity in the phase of channels transmitting portions of the DMRS. For example, a TA update may result in an adjustment to the time domain window and the determination of an actual time domain window. Adjustments to the time domain window may include but are not limited to time shifts, phase shifts, frequency changes, and other similar adjustments.

As further depicted in FIG. 8, signal 808 transmitted by the UE 102 either reports the acknowledgment of the UE 102 uplink time/frequency compensation to the base station 104 to indicate to the base station 104 the successful TA update or reports the planned or the performed TA update instance(s) by providing a compensation report. A compensation report may be any indication of the planned or executed time instances where adjustment to the TA occurs or has occurred. In some embodiments, the compensation report may include an actual time domain window, information for determining the actual time domain window, and/or information for determining the actual time domain window based on the provided time domain window (e.g., offsets).

As further depicted in FIG. 8, another example mechanism for transmitting the compensation report is provided by signal 810. As depicted, in an instance in which the PUCCH is transmitted in the slot preceding the PUSCH repetitions, the UE may provide the base station with a compensation report before the transmission of the PUSCH repetitions transmitted according to the actual time domain window. The compensation report may include information on when the time/frequency pre-compensation may occur such that the base station may determine the boundaries of the actual TDW applied by the UE.

As further depicted in FIG. 8, at block 812, the base station 104 may receive the compensation report including the timing and/or frequency adjustments within the time domain window in the shared data field such that the instances of time when the compensation is performed may be determined. The base station 104 may determine the actual TDWs within the configured nominal TDW for a UE 102 transmission on the uplink communication stream 106 based on the compensation report.

As further depicted in FIG. 8, signal 814 transmitted by the UE 102 may transmit PUSCH and/or PUCCH transmissions with repetitions and with the actual TDWs adjusted according to the determined time instances of time/frequency compensation. In addition, the base station 104 may receive the PUSCH and/or PUCCH transmissions and demodulate the DMRS according to the actual TDW.

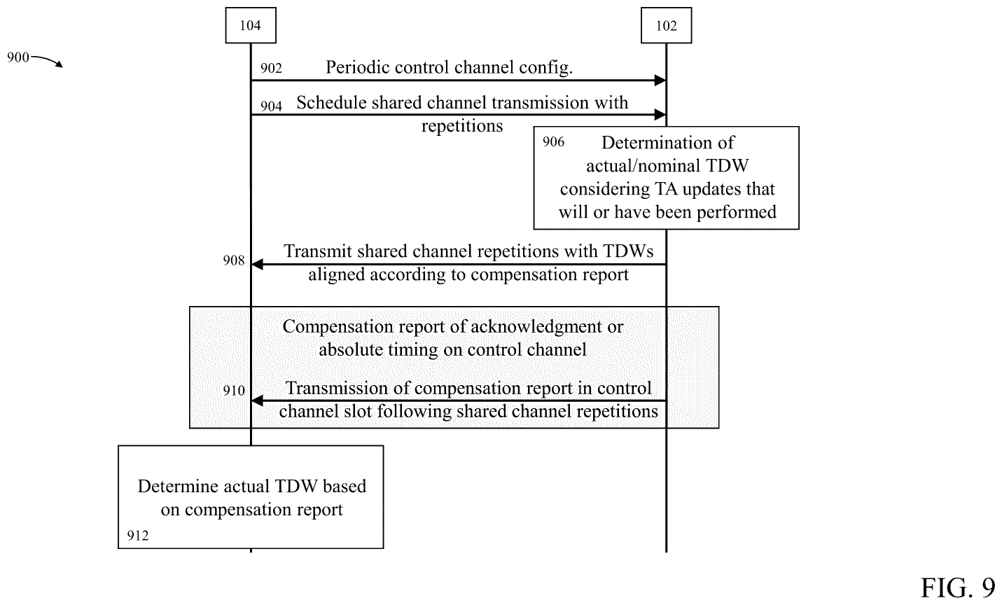

Referring now to FIG. 9, a signal diagram depicting a process 900 for providing a compensation report to a base station 104 is provided. As depicted in FIG. 9, signal 902 transmitted by the base station 104 configures the UE 102 for transmission of periodic control channel message transmissions. In some embodiments, the periodic control channel message transmissions may comprise PUCCH messages.

As further depicted in FIG. 9, signal 904 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling may be especially useful for PUSCH transmissions with repetition.

As further depicted in FIG. 9, at block 906, the UE 102 determines pre-compensation timing and actual TDWs. Certain events may occur within a communication network 102 which prevent the UE 102 from maintaining phase continuity as required for DMRS bundling. Based on any TA updates, the UE 102 may further determine the actual TDWs within the nominal TDW. An actual time domain window may be any time domain window resulting from one or more adjustments to the time and/or frequency within the nominal TDW, for example, the uplink time domain window configured by the base station 104 for the UE 102. In some embodiments, adjustments to the time domain window resulting in an actual time domain window may be the result of an event causing a discontinuity in the phase of channels transmitting portions of the DMRS. For example, a TA update may result in an adjustment to the time domain window and the determination of an actual time domain window. Adjustments to the time domain window may include but are not limited to time shifts, phase shifts, frequency changes, and other similar adjustments.

As further depicted in FIG. 9, signal 908 transmitted by the UE 102 may transmit PUSCH and/or PUCCH transmissions with repetitions in accordance with the actual TDWs calculated at block 906, adjusted according to the determined time instance of time/frequency compensation.

As further depicted in FIG. 9, signal 910 transmitted by the UE 102 either reports the acknowledgment of the UE 102 uplink time/frequency compensation to the base station 104 to indicate to the base station 104 the successful TA update or reports the planned or the performed TA update instance(s) by providing a compensation report. A compensation report may be any indication of the planned or executed time instances where adjustment to the TA occurs or has occurred. In some embodiments, the compensation report may include an actual time domain window, information for determining the actual time domain window, and/or information for determining the actual time domain window based on the provided time domain window (e.g., offsets).

As further depicted in FIG. 9, one example mechanism for transmitting the compensation report may include transmitting the compensation report in the control channel slot following the shared channel repetitions. As depicted, in an instance in which the PUCCH is transmitted in the slot following the PUSCH repetitions, the UE may provide the base station with a compensation report after the transmission of the PUSCH repetitions which were transmitted according to the actual time domain window. The compensation report may include information on when the time/frequency pre-compensation occurred in the PUSCH transmissions such that the base station may determine the boundaries of the actual TDW applied by the UE.

As further depicted in FIG. 9, signal 912 transmitted by the base station 104 may receive the compensation report including the timing and/or frequency adjustments within the time domain window in the shared data field such that the instances of time when the compensation is performed may be determined. The base station 104 may determine the actual TDWs within the configured nominal TDW for the previously transmitted UE 102 transmission on the uplink communication stream 106 based on the compensation report.

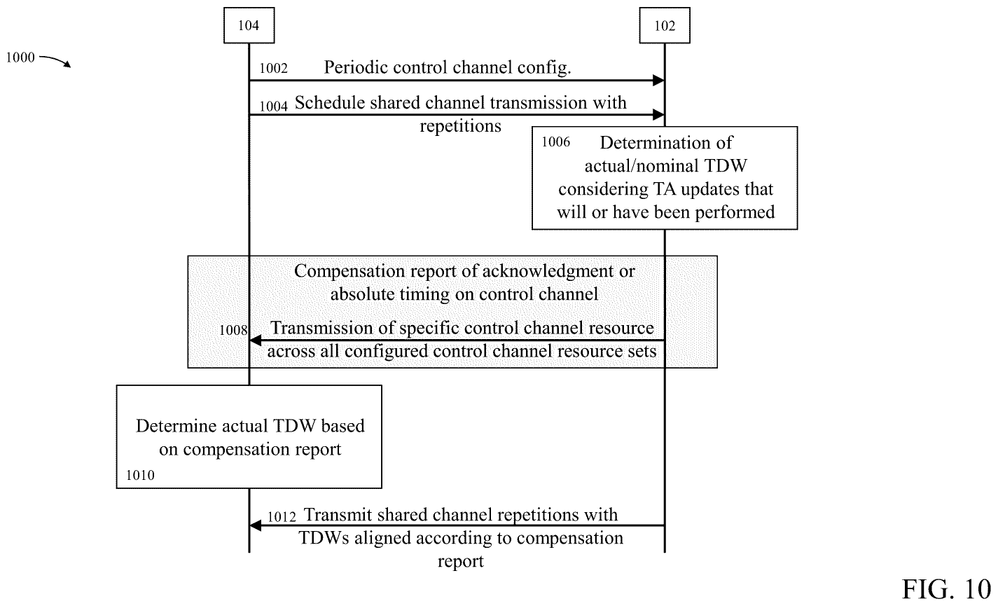

Referring now to FIG. 10, a signal diagram depicting a process 1000 for providing a compensation report to a base station 104 is provided. As depicted in FIG. 10, signal 1002 transmitted by the base station 104 configures the UE 102 for transmission of periodic control channel message transmissions. In some embodiments, the periodic control channel message transmissions may comprise PUCCH messages.

As further depicted in FIG. 10, signal 1004 transmitted by the base station 104 schedules a PUSCH transmission with repetitions. PUSCH transmissions with repetitions may improve the reliability of data transmission from the UE 102 to the base station 104. During a PUSCH transmission with repetitions, the transmitter (e.g., UE 102) transmits the data packet multiple times with different redundancy versions (RVs). The receiver may then combine the received packets and request retransmission of any lost or corrupt packets. DMRS bundling may be especially useful for PUSCH transmissions with repetition as DMRS bundling transmits the DMRS symbols that are associated with PUSCH transmission repetitions coherently.

As further depicted in FIG. 10, at block 1006, the UE 102 determines pre-compensation timing and actual TDWs. Certain events may occur within a communication network 102 which prevent the UE 102 from maintaining phase continuity as required for DMRS bundling. Based on any TA updates, the UE 102 may further determine the actual TDWs within the nominal TDW. An actual time domain window may be any time domain window resulting from one or more adjustments to the time and/or frequency within the nominal TDW, for example, the uplink time domain window configured by the base station 104 for the UE 102. In some embodiments, adjustments to the time domain window resulting in an actual time domain window may be the result of an event causing a discontinuity in the phase of DMRS symbols. For example, a TA update may result in an adjustment to the time domain window and the determination of an actual time domain window. Adjustments to the time domain window may include but are not limited to time shifts, phase shifts, frequency changes, and other similar adjustments.

As further depicted in FIG. 10, signal 1008 transmitted by the UE 102 either reports the acknowledgment of the UE 102 uplink time/frequency compensation to the base station 104 to indicate to the base station 104 the successful TA update or reports the planned or the performed TA update instance(s) by providing a compensation report. A compensation report may be any indication of the planned or executed time instances where adjustment to the TA occurs or has occurred. In some embodiments, the compensation report may include an actual time domain window, information for determining the actual time domain window, and/or information for determining the actual time domain window based on the provided time domain window (e.g., offsets).

As further depicted in FIG. 10, one example mechanism for transmitting the compensation report may include the UE notifying the base station by transmitting a specific control channel resource across all configured control channel resource sets. In such an embodiment, the UE may not send the compensation report containing the absolute timing information or the acknowledgement periodically, but only when an update is needed. The compensation report may be carried via a specific time/frequency control channel, for example, PUCCH-ResourceIdXX across all configured control channel resource sets. Thus, the reception of UCI over the specifically selected control channel resource may be an indicator to the base station that a compensation report has been transmitted.

One example implementation may include allocating some of the control channel resources to a compensation resource set group. The compensation resource set group may comprise control channel resources, such as ResourceIds, that have been allocated as potential resources for transmitting compensation report information. The UE may select a control channel resource allocated for transmitting the compensation report in order to transmit the compensation report containing the actual time domain window. The UE may select the control channel resource based on availability and/or according to a set of pre-defined rules such that the control channel resources may still fulfill any other purposes they may serve. Due to the need to share the control channel resources such that other purposes may be fulfilled, the UE may only choose to transmit the compensation report in an instance in which the compensation report has been updated or otherwise changed.

As a specific example, the UE may allocate PUCCH resources with PUCCH-ResourceIds equal to 124, 125, 126, and 127 to a compensation resource set group, designated for transmitting the compensation report. As described herein, the PUCCH-ResourceIds selected may potentially belong to different PUCCH resource sets supporting other PUCCH formats. Thus, the UE will only use the allocated resource sets when it is necessary to report the acknowledgement or absolute timing through the compensation report, for example, when the compensation report has changed or been updated. The described approach may be advantageous in that the approach applies consistently to all PUCCH formats.

Similarly, in some embodiments, the UE may be configured with a maximum of four PUCCH-ResourceSets. Further, PUCCH-ResourceSetId0 may only contain resources for PUCCH format 0 and PUCCH format 1, and up to thirty-two instances of PUCCH-Resources. Alternatively, PUCCH-ResourceSetId1, PUCCH-ResourceSetId2, and PUCCH-ResourceSetId3 may only contain resource for PUCCH formats 2, 3, and 4, and each PUCCH-ResourceSet can have up to 8 instances of PUCCH-Resource. Further, each PUCCH-Resource has a unique ID across all PUCCH-ResourceSets, thus, the PUCCH resource may be identified by the base station upon reception. Additionally, in some embodiments, the PUCCH-ResourceIds 31, 39, 47, and 55 may not be used at any other time. Thus, the unused resource IDs for the PUCCH transmissions may be utilized to indicate the compensation report determined by the UE. The above concept may be easily extended to cases, wherein only subsets of PUCCH-ResourceSets is configured, and in each of the configured PUCCH-ResourceSets more than one PUCCH-ResourceId is allocated for carrying the compensation report.

In another implementation, the UE may provide information regarding the actual TDW as port of a MAC control element (MAC-CE), where the UE provides information on the exact times at which it will update timing advance parameters. Under such an approach, the UE may be limited to changing the transmit timing only at a dedicated time, for instance every 4^{th} or 8^{th} slot. The UE may lose some freedom with respect to providing compensation reports, however, the UE may guarantee that the phase consistency may remain consistent in the interim.

As further depicted in FIG. 10, at block 1010, the base station 104 may receive the compensation report including the timing and/or frequency adjustments within the time domain window in the shared data field such that the instances of time when the compensation is performed may be determined. The base station 104 may determine the actual TDWs within the configured nominal TDW for a UE 102 transmission on the uplink communication stream 106 based on the compensation report.

As further depicted in FIG. 10, signal 1012 transmitted by the UE 102 may transmit PUSCH and/or PUCCH transmissions with repetitions and with the actual TDWs adjusted according to the determined time instances of time/frequency compensation. In addition, the base station 104 may receive the PUSCH and/or PUCCH transmissions and demodulate the DMRS according to the actual TDW.

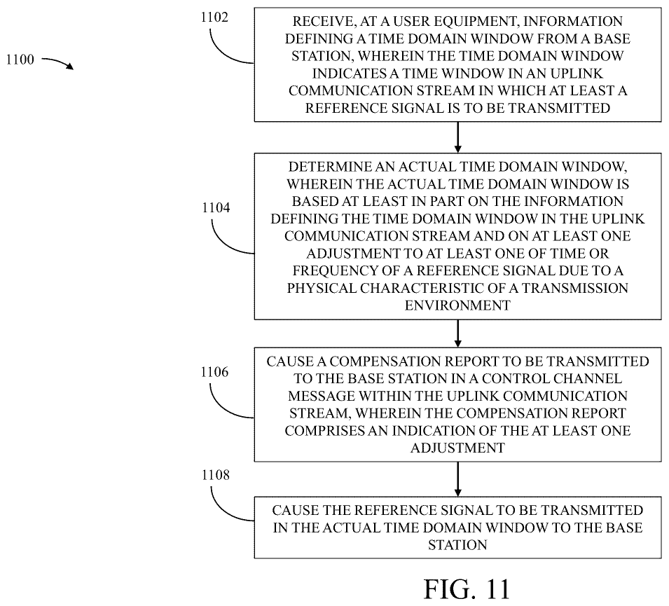

Referring now to FIG. 11, a flowchart depicting a process 1100 for notifying a base station (e.g., base station 104) of a compensation report is provided. At block 1102, an apparatus 200, which may be embodied by or associated with the UE (e.g., UE 102), includes means, such as the processor 202, the communication interface 204 or the like, for receiving information defining a time domain window from a base station, wherein the time domain window indicates a time window in an uplink communication stream in which a reference signal is to be transmitted. As described herein, a base station (e.g., base station 104) may configure the UE to transmit a reference signal, such as a DMRS in a specific time window. The base station may, for example, configure the UE with periodic PUCCH transmissions as described in relation to FIG. 3. The base station may look for the DMRS in the specific configured time window.

At block 1104, the apparatus 200 includes means, such as the processor 202 or the like, for determining an actual time domain window, wherein the actual time domain window is based at least in part on the information defining the time domain window in the uplink communication stream and on at least one adjustment to at least one of time or frequency of a reference signal due to a physical characteristic of a transmission environment. As described in relation to FIG. 3, a UE may consider the relative positions and speed of other components of the communication network, such as the location and speed of the UE, the location and speed of the base station, and/or the location and speed of a satellite in a NTN, to determine any time and/or frequency adjustment to the transmitted signal that may need to be made. Any time or frequency adjustments to the TDW result in an TDW different from the nominal TDW. The UE may coordinate with the base station as to timing of the adjustments to ensure accurate and reliable communications.

At block 1106, the apparatus 200 includes means, such as the processor 202, the communication interface 204 or the like, for causing a compensation report to be transmitted to the base station in a control channel message within the uplink communication stream, wherein the compensation report comprises an indication of the at least one adjustment. A compensation report may include acknowledgement that the UE successfully performed time/frequency compensation, for example, in an instance in which the compensation report is sent after the transmitted data is transmitted on the uplink communication stream. In some embodiments, a compensation report may include absolute timing indicating the milliseconds and/or slot in which the DMRS is to be transmitted. The actual time domain window may be determined based on the compensation report. Once the compensation report is received, the base station may begin looking for the DMRS in the actual time domain window.

A number of methods may be utilized for transmitting the compensation report to the base station. For example, as described in relation to FIG. 4-FIG. 7, the compensation report may utilize a shared data field to implicitly indicate the compensation report. For example, the UE may utilize the cyclical shift parameters, SR parameter, or HARQ ACK/NACK parameter to indicate the compensation report.

In addition, the UE may implicitly transmit the compensation report on the PUCCH resource via a particular PUCCH resource (e.g., PUCCH-resourceID) as described in relation to FIG. 10.

In another embodiment, the compensation report may be transmitted with periodic PUCCH transmission occasions, wherein the UE explicitly indicates the time duration or the UE explicitly indicates acknowledgement by a dedicated data field. Transmitting the compensation report by a dedicated data field is further described in relation to FIG. 3.

In some embodiments, the compensation report may be transmitted via a control channel message on the uplink communication stream in coordination with uplink shared control channel repetition messages as further described in relation to FIG. 8-FIG. 9.

In another embodiment, the compensation report may be transmitted via UCI multiplexing on one of the PUSCH transmissions of the set of scheduled PUSCH repetitions including DMRS bundling. In such an embodiment, the UCI comprising the compensation report may be multiplexed either in the first, the last, or one of the PUSCH transmissions across the PUSCH repetitions. The base station may further configure an interval for such UCI multiplexing, ensuring that the information contained in the compensation report is transmitted in a timely manner, but not in all PUSCH repetitions. Such an embodiment frees up resources which may be otherwise needed to transmit the compensation report with greater frequency.

At block 1108, the apparatus 200 includes means, such as the processor 202, the communication interface 204 or the like, for causing the reference signal to be transmitted in the actual time domain window to the base station.

Utilizing the process 1100 to determine a actual time domain window based on one or more physical characteristics of the transmission environment may enable accurate and efficient communications on a communication network (e.g., communication network 100) as described herein. By determining and reporting the time/frequency compensations through a compensation report, a UE may further improve channel estimation through DMRS bundling and other similar mechanisms. In addition, advanced 5G features such as beamforming, spatial multiplexing, multiple input multiple output (MIMO) communication, and communication on non-terrestrial networks (NTN) may be greatly enhanced.

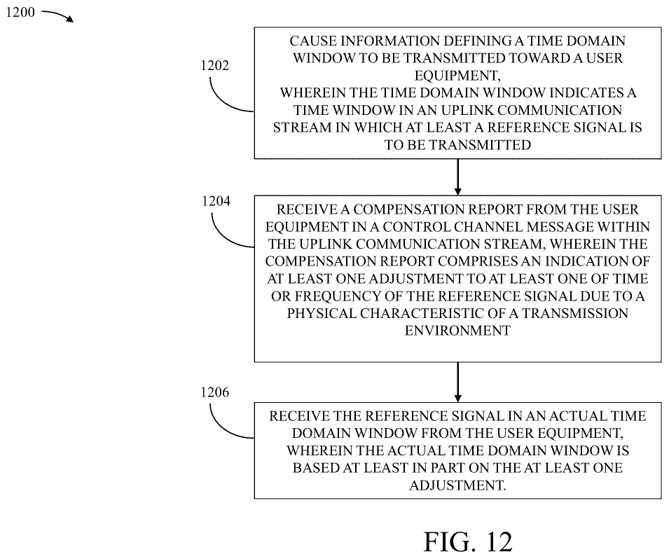

Referring now to FIG. 12, a flowchart depicting a process 1200 for receiving at a base station a compensation report from a UE is provided. At block 1202, an apparatus 200, which may be embodied by or associated with the base station (e.g., base station 104), includes means, such as the processor 202, the communication interface 204 or the like, for causing information defining a time domain window to be transmitted toward a user equipment, wherein the time domain window indicates a time window in an uplink communication stream in which at least a reference signal is to be transmitted. As described herein, the base station may configure the UE to transmit a reference signal, such as a DMRS in a specific time window. The base station may, for example, configure the UE with periodic PUCCH transmissions as described in relation to FIG. 3. The base station may be configured to search for the DMRS in the specified time domain window.

At block 1204, the apparatus 200 includes means, such as the processor 202, the communication interface 204 or the like, for receiving a compensation report from the user equipment in a control channel message within the uplink communication stream, wherein the compensation report comprises an indication of at least one adjustment to at least one of time or frequency of the reference signal due to a physical characteristic of a transmission environment. As described in relation to FIG. 3, a UE may determine and transmit a compensation report based on the physical characteristics of the transmission medium and the physical setup of the communication network. A compensation report may consider, among other things, the relative positions and speed of the components of the communication network, such as the location and speed of the UE, the location and speed of the base station, and/or the location and speed of a satellite in a NTN. Any time or frequency adjustments to the TDW result in an actual TDW in which the DMRS may be sent to ensure accurate and reliable communications. A compensation report may comprise an acknowledgement that the UE successfully performed time/frequency compensation, for example, in an instance in which the compensation report is sent after the transmitted data is transmitted on the uplink communication stream. In some embodiments, a compensation report may include absolute timing indicating the milliseconds and/or slot in which the DMRS is to be transmitted. The actual time domain window may be determined based on the compensation report. Once the compensation report is received, the base station may begin looking for the DMRS in the actual time domain window.

At block 1206, the apparatus 200 includes means, such as the processor 202, the communication interface 204 or the like, for receiving the reference signal in the actual time domain window from the user equipment, wherein the actual time domain window is based at least in part on the at least one adjustment. Once the base station has been notified of an update to the TDW based on the compensation report, the base station may receive the reference signal in the actual time domain window.

Coordinated receipt of the time and frequency adjustments to a transmitted control channel signal may enable accurate and efficient communications on a communication network (e.g., communication network 100) as described herein. Receipt of the time and frequency adjustments through a compensation report may enable utilization of various techniques to improve the transmission speed, accuracy, and reliability of wireless transmissions. Advanced features including beamforming, spatial multiplexing, multiple input multiple output (MIMO) communication, and communication on non-terrestrial networks (NTN) may be greatly enabled by enhanced channel estimation.

FIGS. 11 and 12 are flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by volatile memory and/or non-volatile memory of an apparatus employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to, “comprising only one,” or by using “consisting.”

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

While endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

Many modifications and some embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims.

Moreover, although the foregoing descriptions and the associated drawings describe some embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the at least one processor, cause the apparatus to:
receive information defining a time domain window from a base station,
wherein the time domain window indicates a time window in an uplink communication stream in which a reference signal is to be transmitted;
determine an actual time domain window,
wherein the actual time domain window is based at least in part on the information defining the time domain window in the uplink communication stream and on at least one adjustment to at least one of time or frequency of a reference signal due to a physical characteristic of a transmission environment;
cause a compensation report to be transmitted to the base station in a control channel message within the uplink communication stream,
wherein the compensation report comprises an indication of the at least one adjustment; and
cause the reference signal to be transmitted in the actual time domain window to the base station.

2. The apparatus of claim 1, wherein the at least one memory and the computer program code are configured to with the at least one processor, cause the apparatus to generate the compensation report comprising compensation information related to at least one of a frequency adjustment and a timing adjustment.

3. The apparatus of claim 1, wherein the physical characteristic of the transmission environment comprises at least one of a transmission medium physical characteristic, a base station physical location, or a user equipment physical location.

4. The apparatus of claim 1, wherein the at least one memory and the computer program code are configured to with the at least one processor, cause the apparatus to cause the control channel message to be transmitted in accordance with a physical uplink control channel (PUCCH).

5. The apparatus of any of claim 1, wherein the at least one memory and the computer program code are configured to with the at least one processor, cause the apparatus to cause the compensation report to be transmitted in a dedicated data field of the control channel message.

6. The apparatus of claim 1, wherein the at least one memory and the computer program code are configured to with the at least one processor, cause the apparatus to cause the compensation report to be transmitted in a shared data field of the control channel message.

7. The apparatus of claim 6, wherein the shared data field comprises a base sequence, and wherein the compensation report is encoded by applying a cyclic shift to the base sequence.

8. The apparatus of claim 6, wherein the shared data field is at least one of a modulation symbol data field or a resource selection data field.

9. The apparatus of claim 1, wherein the at least one memory and the computer program code are configured to with the at least one processor, cause the apparatus to assign a subset of control channel resource to a compensation resource set group, and in an instance in which the compensation report is updated, cause the compensation report to be transmitted on an available compensation resource set in a control channel message.

10. The apparatus of claim 1, wherein the uplink communication stream comprises one or more shared channel repetitions and wherein the at least one memory and the computer program code are configured to with the at least one processor, cause the apparatus to cause the compensation report to be transmitted in coordination with the shared channel repetitions.

11. The apparatus of claim 9, wherein the at least one memory and the computer program code are configured to with the at least one processor, cause the apparatus to cause the compensation report to be transmitted after the shared channel repetitions, wherein the compensation report indicates the at least one adjustment for a previously transmitted reference signal.

12. The apparatus of claim 10, wherein in an instance in which the one or more shared channel repetitions do not fill an allotted time slot for shared channel repetitions, wherein the at least one memory and the computer program code are configured to with the at least one processor, cause the apparatus to cause an acknowledge control channel message indicating the at least one adjustment of the reference signal to be transmitted.

13. The apparatus of claim 1, wherein the compensation report acknowledges transmission of the reference signal wherein the at least one adjustment has been or will be applied.

14. The apparatus of claim 9, wherein the at least one memory and the computer program code are configured to with the at least one processor, cause the apparatus to cause the compensation report to be transmitted before the shared channel repetitions, wherein the compensation report indicates the at least one adjustment for a future reference signal.

15. An apparatus comprising at least one processor and at least one memory including computer program code, the at least one memory and the computer program code configured to, with the at least one processor, cause the apparatus to:
cause information defining a time domain window to be transmitted toward a user equipment, wherein the time domain window indicates a time window in an uplink communication stream in which a reference signal is to be transmitted;
receive a compensation report from the user equipment in a control channel message within the uplink communication stream,
wherein the compensation report comprises an indication of at least one adjustment to at least one of time or frequency of the reference signal due to a physical characteristic of a transmission environment; and
receive the reference signal in an actual time domain window from the user equipment,
wherein the actual time domain window is based at least in part on the at least one adjustment.

16. The apparatus of claim 15, wherein the at least one memory and the computer program code are configured to with the at least one processor, cause the apparatus to receive the compensation report comprising compensation information related to at least one of a frequency adjustment and a timing adjustment.

17. The apparatus of claim 15, wherein the physical characteristic of the transmission environment comprises at least one of a transmission medium physical characteristic, a base station physical location, or a user equipment physical location.

18. The apparatus of claim 15, wherein the at least one memory and the computer program code are configured to with the at least one processor, cause the apparatus to receive the control channel message in accordance with a physical uplink control channel (PUCCH).

19. The apparatus of claim 15, wherein the at least one memory and the computer program code are configured to with the at least one processor, cause the apparatus to receive the compensation report in a dedicated data field of the control channel message.

20. The apparatus of claim 15, wherein the at least one memory and the computer program code are configured to with the at least one processor, cause the apparatus to receive the compensation report in a shared data field of the control channel message.
